(19) United States
(12) Patent Application Publication
(10) Pub. No.: US 2015/0206099 A1
(43) Pub. Date: Jul. 23, 2015

(54) INTEGRATED THREE DIMENSIONAL PRODUCT ACCESS AND DISPLAY SYSTEM

(71) Applicant: TYCO ELECTRONICS RAYCHEM BVBA, Kessel-Lo (BE)

(72) Inventors: Davy Bockx, Westerlo (BE); Roel Modest Willy Byron, Aarschot (BE); Serge Merchez, Kessel-Lo (BE); Wouter Jan Renild Foulon, Leuven (BE)

(21) Appl. No.: 14/413,986

(22) PCT Filed: Jul. 11, 2013
(86) PCT No.: PCT/EP2013/064667

§ 371 Date: Jan. 9, 2015

Related U.S. Application Data
(60) Provisional application No. 61/670,487, filed on Jul. 11, 2012.

(51) Int. Cl. G06Q 10/10; G06F 17/30; H04L 29/06

(52) U.S. Cl. CPC G06Q 10/10; H04L 67/42; G06F 17/30011; G06F 17/30864

(57) ABSTRACT

Systems and methods for accessing product data managed by a product data server are disclosed. One system includes a product data server hosting a database that includes a first product document describing a product, the document and having a first document format and identified using a first data identifier having a first data identifier format. The database also includes a second product document describing the product and having a second document format different from the first document format, the second product document including dimensional data associated with at least a part of the product, the second product document identified using a second data identifier different from the first data identifier. The product data server includes a product linker component configured to associate the first product document and the second product document with the product, and also includes a dimensional renderer component.

### CROSS-REFERENCE TO RELATED APPLICATIONS

The present application claims priority from U.S. Provisional Patent Application No. 61/670,487, filed on Jul. 11, 2012, the disclosure of which is hereby incorporated by reference in its entirety.

### TECHNICAL FIELD

The present application relates generally to product data storage and access systems. In particular, the present disclosure relates to an integrated three-dimensional product access and display system.

### BACKGROUND

Product data generated by an organization comes in many forms, depending upon a product's particular stage in development. For example, at an early stage, product data can include specification sheets, design parameter lists, or feature lists. At this point in a product's lifecycle, that product may be referred to, within an organization, by a project name or other code name, since a finalized product is not yet ready to be marketed. Following definition of the product's requirements, additional data can be generated at a higher level of specificity. For example, during a detailed design phase, a product may be described by one or more engineering drawings, illustrating, for example, various views and dimensions of a product, illustrating its mechanical features, schematic drawings illustrating electrical or functional features, or other types of engineering drawings used to describe the overall detailed design. While these drawings sometimes include the project name associated with them, very often the drawings are instead given part numbers and stored entirely separately from the documents defining the overall product specification. In still later phases of product development, when marketing and/or promotional documents are generated, these documents are often associated with a product's marketing name or an overall product number. Alternatively, even when a marketed product is associated with a product number, such as an assembly number, that assembly number may vary across different regions in which the product is sold.

It is noted that the above separation of product documentation leads to inefficiencies. For example, a marketing or sales individual may wish to provide additional information to a customer about sizing or specifications of a particular product; however, if that documentation describing the product is referred to only by a project codename or a part number, the marketing department may be unaware of that information, and therefore may be unable to locate the correct document. Furthermore, existing systems have additional limitations relative to presenting product information to a customer, because often during a lifespan of a product, the product specifications may change, causing a change in size, shape or functionality. As such, ordering information may become out-of-date, or incorrect specifications may be passed to a customer due to revision controls, or failure to propagate such design changes to marketing or ordering documents associated with that product may occur. Furthermore, marketing and sales individuals may desire access to engineering documents, and may not be authorized to view such documents. No existing systems are available which expose and integrate engineering, marketing, and sales documents and part/product numbering schemes, while also ensuring that the correct individuals are granted access to appropriate materials.

For these and other reasons, improvements are desirable.

### SUMMARY

In accordance with the following disclosure, the above and other issues are addressed by the following:

In a first aspect, a system for accessing product data is disclosed. The system includes a product data server hosting a database. The database includes a first product document describing a product, the first product document generated by a first user within a first community of interest and having a first document format and identified using a first data identifier having a first data identifier format. The database also includes a second product document describing the product and having a second document format different from the first document format. The second product document is generated by a second user within a second community of interest different from the first community of interest and includes dimensional data associated with at least a part of the product. The second product document is identified using a second data identifier different from the first data identifier. The system further includes a product linker component operating on the product data server and configured to associate the first product document and the second product document with the product. The system also includes a dimensional renderer component configured to generate one or more graphical images in response to a request from a client system. The one or more graphical images are generated based at least in part on the dimensional data in the second product document on or after a time at which the request is received.

In a second aspect, a method of accessing product data managed by a product data server is disclosed. The method includes generating a user interface displayable on a client computing system, the user interface providing a visual search interface useable to select one or more products by visual appearance, the visual appearance defined at least in part by a dimensional thumbnail image. The method further includes transmitting a selection of the dimensional thumbnail image to the product data server. The method also includes, in response, receiving a listing of one or more documents associated with the product represented by the dimensional thumbnail image and available for retrieval from the product data server. The documents are generated by a plurality of different communities of interest and each having a different document format and identified by identifiers having different formats, the documents including a view of at least a portion of the product, computer-aided design drawings of the product, and ordering information associated with at least part of the product.

In a third aspect, a computer-storage medium configured to store computer-executable instructions is disclosed. The computer-executable instructions, when executed, cause the computing system to execute a method for accessing product data managed by a product data server. The method includes generating a user interface displayable on a client computing system, the user interface providing a visual search interface useable to select one or more products by visual appearance, the visual appearance defined at least in part by a dimensional thumbnail image. The method further includes transmitting a selection of the dimensional thumbnail image to the product data server. The method also includes, in response, receiving a listing of one or more documents associated with the product represented by the dimensional thumbnail image and available for retrieval from the product data server. The documents are generated by a plurality of different communities of interest and each having a different document format and identified by identifiers having different formats, the documents including a three-dimensional view of at least a portion of the product, computer-aided design drawings of the product, and ordering information associated with at least part of the product.

In a further aspect, a method of accessing product data includes receiving, at a proxy server, a request for access from a portable device. The method further includes receiving, at the proxy server, user credentials from a user of the portable device, and, based on the identity of the portable device and the user credentials permitting access by the portable device to a web server. The method also includes generating a user interface providing a visual search interface useable to select a part and view documentation associated with one or more products, kits, or parts, the documentation including: a three dimensional view, a thumbnail, a design drawing, a product specification, product collateral, and pricing information, wherein access rights to the documentation varies based on the user credentials of the user.

In a still further aspect, a system for accessing product data is disclosed. The system includes a product data server storing information describing a plurality of products, each product including one or more options, one or more kits associated with each option, and one or more parts including in each kit. The system also includes an administrative web server providing an administrative user interface allowing an administrative user to extract data from an engineering server for integration into the product data server. The system further includes a web server providing a user interface allowing users of portable devices to view documents associated with each product, the documents including documents identified by different naming conventions, including product assembly numbers, order numbers, item numbers, and release numbers, the user interface presenting a three-dimensional version of the product and the documents including one or more of installation instructions, an ordering guide, a bill of materials, pricing data, design specifications, and design drawings. The system also includes a proxy server configured to control access to the web server and data in the product data server based on identification of a client device and a user of the client device.

### BRIEF DESCRIPTION OF THE DRAWINGS

FIG. 1 is a schematic view of an integrated three dimensional product access and display system, according to an example embodiment of the present disclosure;

FIG. 2 is a generalized process flow for product development with which the integrated three dimensional product access and display system of FIG. 1 can be implemented;

FIG. 3 is a logical block diagram of functional and data components capable of being included in a product data server, according to an example embodiment;

FIG. 4 is a logical block diagram illustrating modules incorporated into client interface software for connection to a product data server, according to an example embodiment;

FIG. 5 is a schematic view of an integrated three dimensional product access and display system, according to a further example embodiment of the present disclosure;

FIG. 6 is a block diagram illustrating interactions within the integrated three dimensional product access and display system of FIG. 5;

FIG. 7 is a hierarchical illustration of product and part data incorporated into the integrated three dimensional product access and display systems discussed herein;

FIG. 8 is a flowchart of a method for creating parts or products in the integrated three dimensional product access and display systems discussed herein;

FIG. 9 is a flowchart of a method for uploading engineering data into the integrated three dimensional product access and display systems discussed herein;

FIG. 10 is a flowchart of a method for establishing a connection to the integrated three dimensional product access and display systems discussed herein;

FIG. 11 is a flowchart of a method for accessing product data in the integrated three dimensional product access and display systems discussed herein;

FIG. 12 illustrates an electronic computing device with which aspects of the system can be implemented;

FIG. 13 illustrates a block diagram depicting user interface features of the integrated three dimensional product access and display systems discussed herein;

FIG. 14 is a depiction of an example user interface presented on a mobile device and as generated by the client interface software of FIGS. 1-11;

FIG. 15 is a depiction of the example user interface of FIG. 14, illustrating a menu option;

FIG. 16 is a depiction of the example user interface of FIG. 14, illustrating user manipulation of a three-dimensional representation of a selected product, and menu options for manipulating the current product;

FIG. 17 is a depiction of the example user interface of FIG. 14, illustrating selection of an “accessories” tab;

FIG. 18 is a depiction of the example user interface of FIG. 14, illustrating the available “accessories” associated with the current product;

FIG. 19 is a depiction of the example user interface of FIG. 14, illustrating a refining search among available “accessories” associated with the current product;

FIG. 20 is a depiction of the example user interface of FIG. 14, illustrating product information associated with the current product;

FIG. 21 is a depiction of the example user interface of FIG. 14, illustrating dimensional data and engineering drawings associated with the current product;

FIG. 22 is a depiction of the example user interface of FIG. 14, illustrating an associated product with which a selected product can be installed;

FIG. 23 is a depiction of the example user interface of FIG. 14, illustrating placement of the selected product with the related product of FIG. 22;

FIG. 24 is a depiction of a product category selection interface useable in connection with the user interface of FIG. 14, in particular illustrating navigation and selection of a product via a product category menu;

FIG. 25 is a depiction of a product subcategory selection interface useable in connection with the user interface of FIG. 14, in particular illustrating navigation and selection of a product via a product subcategory menu;

FIG. 26 is a depiction of a product selection interface useable in connection with the user interface of FIG. 14;

FIG. 27 is a depiction of a second example user interface presented on a mobile device and as generated by the client interface software;

FIG. 28 is a depiction of an option selection screen in the second example user interface of FIG. 27;

FIG. 29 is a depiction of a kit selection screen in the second example user interface of FIG. 27;

FIG. 30 is a depiction of kit and rotation selection screens in the second example user interface of FIG. 27;

FIG. 31 is a depiction of the second example user interface of FIG. 27 including a download interface region;

FIG. 32 is a depiction of an administrative user interface useable to access and edit data within the integrated three dimensional product access and display systems discussed herein, and in particular illustrating a user authentication screen;

FIG. 33 is a depiction of the administrative user interface of FIG. 32, depicting a categories tab and associated navigation to category screens;

FIG. 34 is a depiction of interrelationships between assembly and category screens in the administrative user interface of FIG. 32;

FIG. 35 is a depiction of the administrative user interface of FIG. 32, in particular illustrating an assemblies tab;

FIG. 36 is a depiction of the administrative user interface of FIG. 32, in particular illustrating a parts tab; and

FIG. 37 is a depiction of the administrative user interface of FIG. 32, in particular illustrating a collateral tab.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general the present disclosure relates to methods and systems for managing an accessing product data from a product database in a way such that engineering changes can be linked to customer-accessible information, and such that customers and sales personnel can access realtime or near-realtime product dimensional data associated with a product or a part of a product. Additionally, the present disclosure relates to systems, including user interfaces, which facilitate locating specific products or product parts, through use of a visual search system in which a user can browse three-dimensional images of products to locate a specific product required for his/her application. Using the systems and methods described herein, users of various types within an organization can maintain their own documents consistently with past practices, while at the same time establishing a link among all of the different types of product documents available for a specific product, thereby facilitating improved communication of engineering changes to other parts of an organization, such as sales staff, customers, and management.

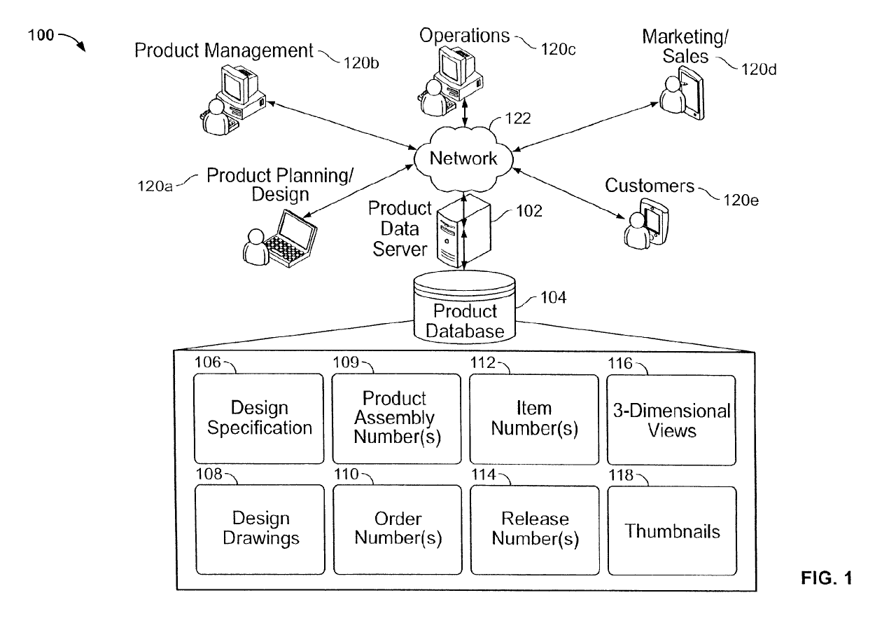

Referring now to FIG. 1, a schematic view of an integrated three-dimensional product access and display system 100 is disclosed. The system 100 includes a product data server 102 that hosts a product database 104. The product data server 102 can be any of a variety of types of computing systems capable of maintaining a database and managing/fulfilling search requests for particular part or ordering information. Although in the embodiment shown the product data server 102 is illustrated as a single computing system, in alternative embodiments, two or more computing systems could be used to implement the functionality of the server as described herein.

The product database 104, as further described below, stores each of the various types of information an organization may typically store that describes products provided by that organization. For example, for a design and manufacturing organization, the product database can include (as shown in the embodiment of FIG. 1): a design specification 106; design drawings 108 associated with each part of a particular product, as well as overall assembly drawings associated with that product; product assembly numbers 109; ordering numbers 110 used in each of the geopolitical regions in which the product is offered for sale; item numbers 112, such as numbers associated with each product associated with an order; and release numbers and separate revision releases 114, corresponding to updated designs of a particular product, such that each product may have a number of different parts suitable to be included in that product (e.g., in case of an updated subassembly within the product). In addition to the above, one or more specific views of the product may be stored in the product database 104, such as three-dimensional views 116 and dimensional thumbnail views 118, useable as further discussed below to allow for improved visual search of the products maintained in the product database 104.

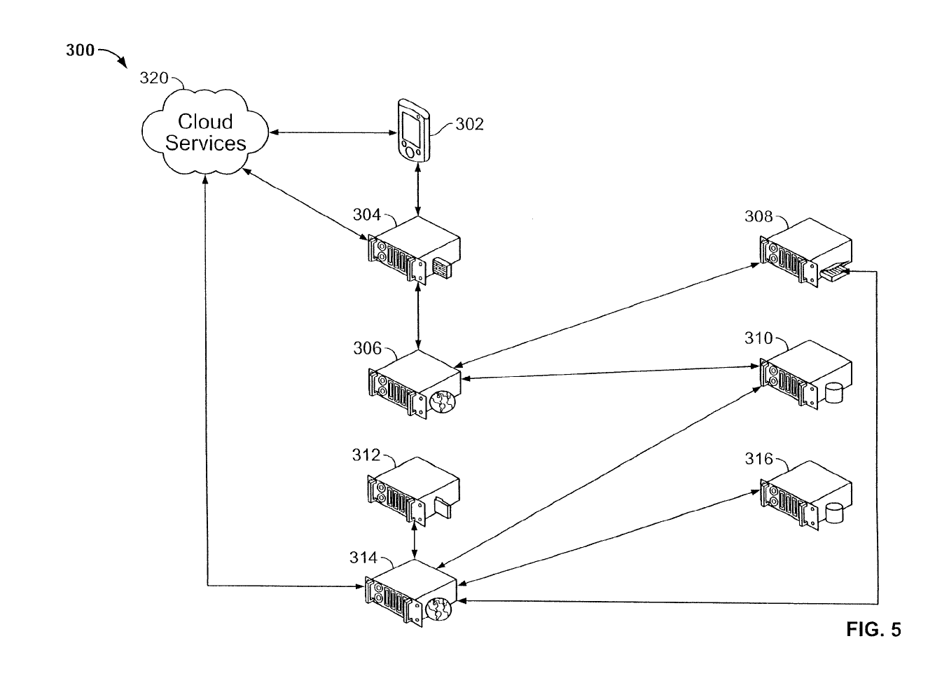

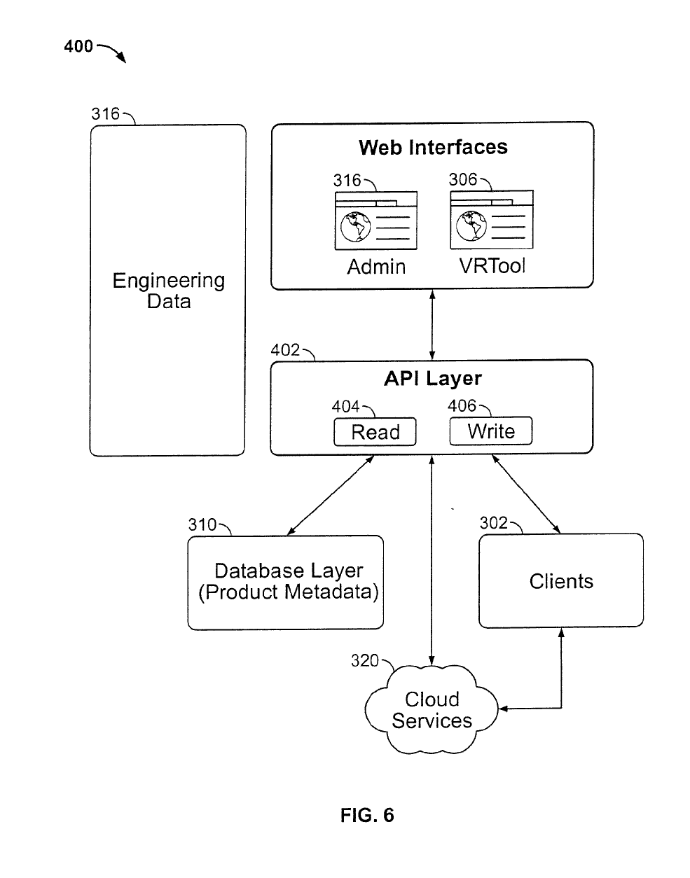

In example embodiments, product database 104 can be constructed as a relational database, and/or can be distributed across one or more computing systems or distributed in a cloud computing environment. In an example embodiment, product metadata describing each of the parts included in the database could be stored locally, and used to control access to a large-scale, remote database containing product files (e.g., engineering files, such as the three-dimensional views 116 and/or design drawings 108 discussed above. One example of such an arrangement is discussed below in connection with FIGS. 5-6. In such embodiments, a database (e.g., product database 104) containing product metadata could store a plurality of tables used to describe each part, and to interrelate parts or drawings of different types illustrating the same part. In one example embodiment, a category table could be used to search among parts, with an assembly table defining parts associated with each assembly. Separate part and assembly image tables, as well as a collateral table, reference images or parts, or associated marking information, for each part or assembly. Of course, other arrangements could be used as well.

In the embodiment shown, a plurality of users 120a-e, each representing a different community of interest, are illustrated. By community of interest, it is intended that each of the users 120a-e generally have a particular role within an organization, such as, in a typical organization, engineering personnel 120a; product management 120b; operations personnel 120c; sales personnel 120d; and customers 120e (typically not part of an organization, but rather interfaced to that organization). Other communities of interest may exist as well. As illustrated, each of the users of client systems 120 can contact the product data server via a communications network 122 (e.g., the Internet), and, as discussed below, execute one or more browsing or searching functions to locate product data, or submit additional product data that can be managed at the product data server 102 such that it can be associated with the product irrespective of its file name or type. As further discussed below, the present disclosure provides a system by which various users 120a-e, in different communities of interest, can each access product data, and different levels of access rights may be provided to each user or community of interest, depending upon the granted access rights of that user.

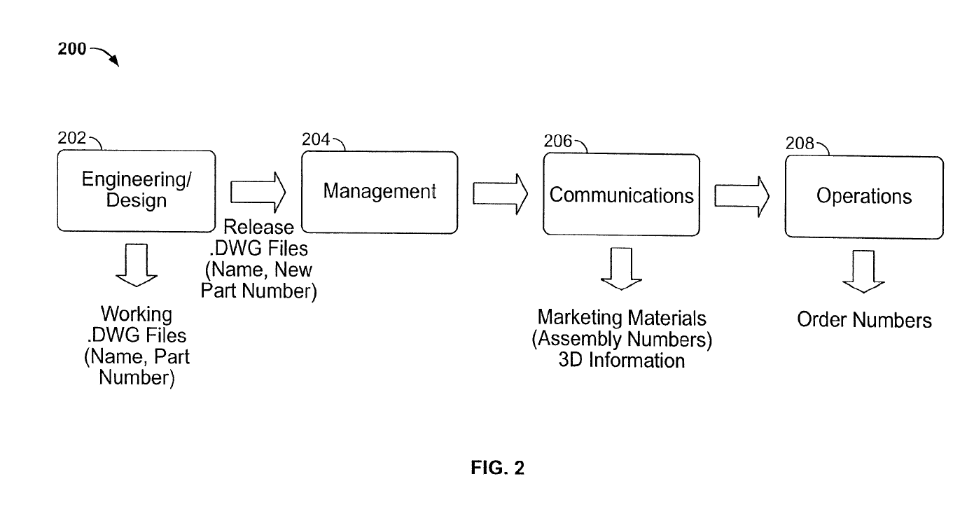

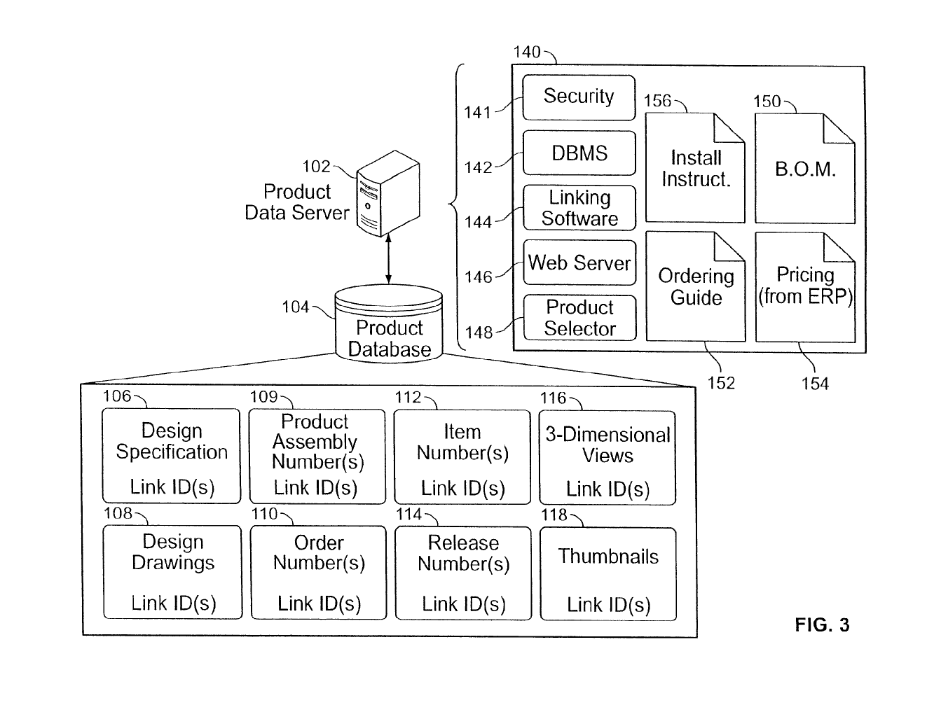

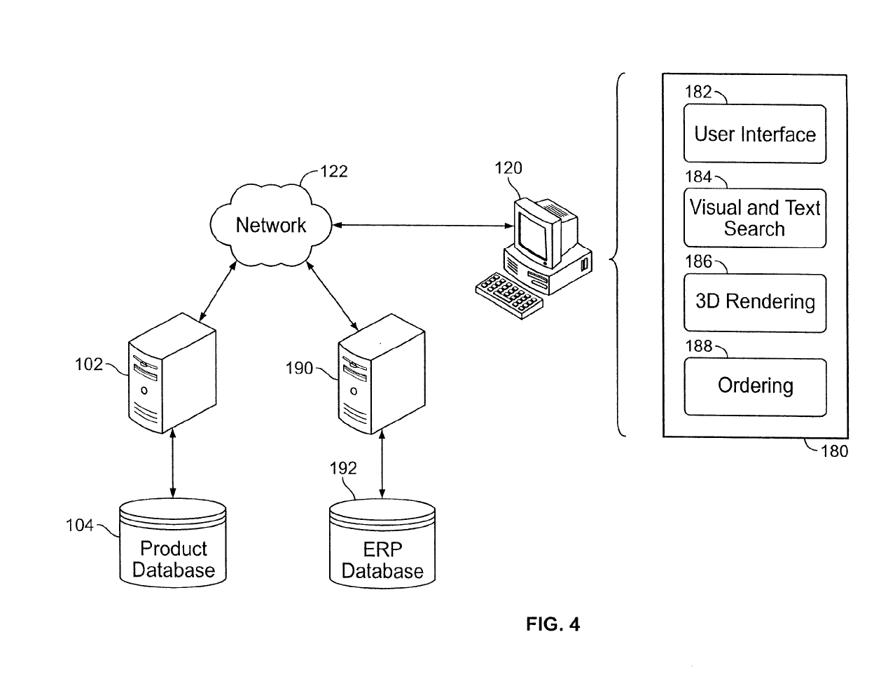

Referring now to FIG. 2, an example generalized process flow 200 for product development within which the integrated three dimensional product access and display system of FIG. 1 can be implemented. The process flow 200 highlights issues in existing product data management systems, and as discussed in further detail below in connection with FIGS. 3-4, illustrates how the integrated three-dimensional product access and display system 100 allows users to overcome challenges presented by such existing systems by linking data, including real-time or near-realtime edited three-dimensional data, in a product database.

As seen in FIG. 2, the process flow 200 generally begins at a design phase 202, in which product specifications (e.g., design specification 106) and engineering drawings (e.g., design drawings 108) of a product are created. Typically, product specifications can be stored in any of a variety of types of word processing or spreadsheet application programs, and define operational characteristics desired of a product. The engineering drawings, generated using computer-aided design tools, are generally created in a program incompatible with the programs used to create the product specifications, and are stored using a different file naming convention and a unique numbering format. For example, each part included in an engineering drawing may have a part name and a part number during the time in which that engineering drawing is created. When the drawing is complete, it is “released” and the released drawing is usually assigned its own name and number. This allows the engineering personnel to release a part, but if refinements are necessary, a new release number can be assigned to subsequent improvements to the part, while preserving the initial part release number for purposes of tracking the original released design.

A product management phase 204 allows management personnel to review the released part drawings, and generally to establish various required tracking numbers useable by communications and sales personnel. For example, the product management phase 204 may include establishing pricing of the product, which may be stored separately, and defined on a per-product basis. As such, because engineering drawings are created on a per-part basis and a product may include multiple parts or part revisions, correspondence among the pricing information and engineering information is often difficult.

A communications phase 206 generally includes generating marketing materials associated with the product, such as instructions for use, a part catalog, or other information describing a product. Furthermore, an operations phase 208 may involve generating order numbers to be used when ordering a particular part or product. The order numbers may be associated with particular orders, and may reference part numbers that vary according to the specific geographical region in which that part or product is sold.

In general, and referring to both of FIGS. 1-2, because of the differing phases of product development and the availability of information at the time of each of those phases, each of the users 120a-e can access the product data server 102, but may only have or know partial information about a particular part or product, such that it may be difficult for one such user to access relevant information provided to the database by another such user. In addition, during the life cycle of a particular product, different data associated with that product may be available. As such using the various features of the present disclosure, as each document becomes available, it is linked to a three-dimensional model of that product, such that users can browse and/or search for a product, view its three-dimensional representation, and then access any available data associated with that product (e.g., datasheets or specification documents at any time after early development, or up to and including marketing materials, bills of materials, price lists, or other documents during a product release phase). Furthermore, additional descriptive details regarding each product, such as sales or order information, or availability information (e.g., overall or by region), can be included as well.

In a simple example of use of the systems described herein, a customer 120e is likely to know an appearance, and possibly an order number (or even a part number) for a product or portion of a product that customer wishes to view. However, engineering personnel 120a designing the product may have updated a design of a part of the product in an engineering drawing, which is assigned a revision number and a specific drawing name and number. As further discussed below, linking components within the product data server 102 allow the customer to access a product using a name or number, or visual appearance, that the customer is familiar with, but also obtain the most up-to-date released engineering drawings for that product.

Referring now to FIG. 3, a logical block diagram of functional and data components capable of being included in a product data server 102 is illustrated. In the embodiment shown, the product data server 102 manages the product database 104, but also includes operational software 140 stored thereon, allowing the product data server 102 to respond to requests from remote client computing systems (operated by users, such as users 120a-e, and therefore referred to generally herein as client systems 120) for part or product information.

In the embodiment shown, the operational software 140 includes a database management system 142, linking software 144, a web server interface 146, and a product selector component 148. The database management system software 142 configured to manage storage of data in product database 104; the database management system software can be any of a variety of relational or transactional database management software systems.

The linking software 144, in the embodiment shown, can be used to associate data records stored in the product database 104 with a particular product or product family, such that data having a variety of different formats or created by different users in different communities of interest (having different naming conventions or identifiers) can be linked to a common product. In an example embodiment, the linking software 144 can be implemented using WindChill PDMLink software provided by Parametric Technology Corporation of Needham, Mass. Other linking software could be implemented as well.

The web server interface 146 provides access to the product database 104, and can maintain security of the data in the database, for example by allowing or denying access to certain data based on the identity of the user accessing the data. For example, engineering personnel 120a may be able to access unreleased engineering drawings so that they may work on those drawings, but customers 120e would not have access to such unreleased product information. Other segmentation of data, for example by communities of interest, is possible as well, depending upon the security needs specific to a particular organization. As such, optionally (to the extent not incorporated into the web server interface 146, the linking software 144, or the database management system 142, a security module 141 can be incorporated into the operational software 140 to control distribution of data to different users, according to those users' roles. For example, although at a time after a product is released, certain documents associated with that product may be releasable only to a select group of individuals. For example, the security module 141 can ensure that customers do not have access to early drafts of development documents or order numbers/prices from other customers, but would have access to released drafts, product descriptions, orders, installation instructions, marketing materials, bills of materials, and other relevant information. On the other hand, individuals associated with the entity offering the product, such as sales personnel or engineers, have access to all or nearly all of the documents uploaded to the database.

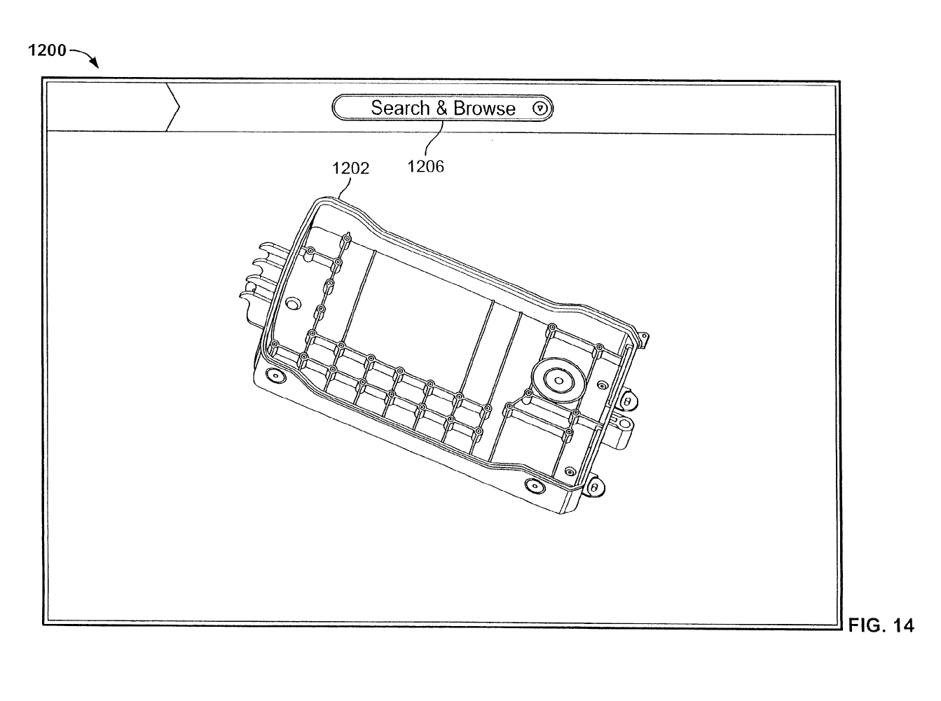

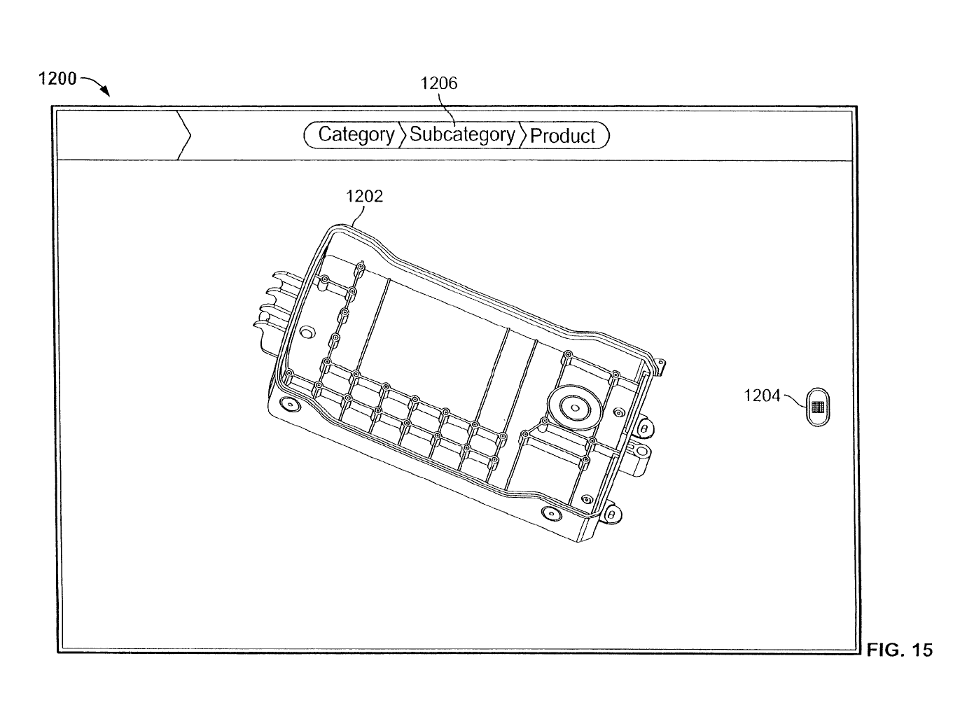

The product selector component 148 generates a displayable product selection for use by a client system 120, for example to allow that client system to browse among the various products and parts available in the product database 104. The product selector component 148 can, in various embodiments, generate a definition for a graphical user interface with which a user of client system 120 can browse through various reports available to that particular user (e.g., ordering guides, installation instructions, bills of materials, and pricing, as discussed below), as well as browsing or keyword searching based on particular products. In one example embodiment, the product selector component 148 allows a user to select a product family and presents a scrollable graphical user interface illustrating a series of dimensional thumbnail drawings (e.g., perspective three-dimensional drawings) to a client computing system, such that a user can scroll through those drawings to locate a desired part or product. In examples of such a graphical user interface, various navigation schemes can be used; in one example scheme, a “cover flow”—style set of scrollable tiles is presented. Other navigation schemes could be presented using the product selector component 148 as well. One example of a user interface is provided in FIGS. 14-31, described below.

In addition to the various software systems within the operational software 140, the product data server 102 can be configured to generate a plurality of reports associated with the data stored in the product database 104. For example, based on the linked information as defined using the linking software 144, a bill of materials 150 could be generated, and could include a current list of parts to be used in a particular product, with each part in the list linked to specific engineering drawings, product specifications, item numbers, order numbers, or other documentation describing product. Additionally, an ordering guide 152 could be generated, which could include the most up-to-date product versions offered, based on a revision history of engineering drawings available in the product database 104. Furthermore, using the product identifier defined using the linking software and associated with each of the pieces of information in the product database 104 (as shown by the “Link IDs” identifier), pricing information 154 can be integrated into a report alongside the various data associated with a product, such as could be retrieved from a separate computing system, such as an enterprise resource planning system. Finally, other information could be maintained or generated as well based on up-to-date engineering data, such as up-to-date installation instructions 156, or other types of information that may be needed to be communicated to sales personnel or customers based on a change to an engineering design.

Referring now to FIG. 4, a logical block diagram of a portion of the integrated three-dimensional product access and display system 100 is show that illustrates modules incorporated into client interface software 180. The client interface software 180 is executable on a computing system of a user, such as any of users 120a-e described above. The client interface software 180 is configured to allow communicative connection to the product data server 102, and can be implemented, for example, as client-specific software (e.g., a desktop or mobile application) or within a browser window, with the definition for the client interface software generated at the product data server 102 itself.

In the embodiment shown, the client interface software 180 includes a user interface module 182, a search module 184, a three-dimensional rendering module 186, and an ordering module 188.

The user interface module 182 presents a user interface as defined by the product selector component 148, and renders the “cover flow” navigation scheme provided on the client computing system. The search module 184 allows a user to search by keyword, or alternatively to search by physical part appearance. In some example embodiments, the search module 184 allows a user to view three-dimensional thumbnail images of parts, such that the user can select an appropriate part for viewing, editing, or ordering. Once selected, a three-dimensional rendering module 186 can be used to receive computer-aided design drawings of the selected part or product, and can render a manipulable three-dimensional image at the client system. This three-dimensional image can also be exported for use in other software systems, for example to ensure its compatibility within a product being made by a customer. An ordering module 188 then cooperates with the product data server 102 and a separate enterprise resource planning server 190 and associated database 192, which can provide pricing and availability information.

Although modules 182-188 are shown in the example embodiment, it is recognized that additional or alternative modules could be incorporated into client interface software as well. For example, in the case of an engineering personnel 120a, that user may wish to search for a particular part or product using the search module 184, but may have limited use for the ordering module 188. Instead, such a user may wish to use a data management module to upload additional documentation describing the product to the product data server 102, which can then be provided to the linking software 144 to associate the documentation with the correct product or products, and then to the database management system 142 for storage in an appropriate location within the product database 104. Other types of modules could be included as well, in still further alternative embodiments. Referring now to FIGS. 5-13, example embodiments of computing systems and methods useable to implement the methods and systems for managing an accessing product data from a product database in a way such that engineering changes can be linked to customer-accessible information, and such that customers and sales personnel can access realtime or near-realtime product dimensional data associated with a product or a part of a product.

Referring first to FIG. 5, an example computing arrangement 300 is shown in which access to product data is provided to a client device, such as portable device 302. As noted above, portable device 302 can be any of a variety of computing devices, such as a tablet or laptop device.

When a user of the portable device 302 (e.g., any of users 120a-e) wishes to access engineering data, such as for engineering products, the portable device will access a proxy server 304, which controls access to server data. The portable device 302 can be checked against a whitelist of approved devices by the proxy server 304, which then allows the portable device 302 to access a web server 306. The web server 306 will provide to the portable device 302 a web page including a login prompt, requiring the user of the portable device 302 to enter authentication information that is checked against entries at a directory services server 308. Upon authorizing the user of the portable device 302, that user can receive data from a database server 310, which stores metadata associated with various parts or part assemblies.

In addition to access via the portable device 302, a web interface, including a file server 312 and a web server 314, can be provided for purposes of administration of the database server 310, including adding or editing of parts or part assemblies, editing information associated with such parts or part assemblies, or importing such data from an engineering server 316. In some such embodiments, the web server 314 will pull data (e.g., engineering drawings of parts or assemblies) from the engineering server 316, and generate specific data files and metadata associated with that data. The web server 314 will then pass translated data files to the file server 312, and also pass data files to the cloud services storage 320, and metadata to the database server 310.

In some such embodiments, and as recognized based on this example arrangement, when a portable device 302 accesses data at database server 310, that data can correspond simply to metadata associated with parts and part assemblies available within the computing arrangement 300. To the extent that larger sized, underlying files are required (e.g., the 3D views, 2D drawings, collateral documents, etc.), such documents can be retrieved by the portable device 302 from cloud services storage 320.

It is noted that access rights within the overall system are controlled both based on user authentication, in the case of both an administrative web interface and in the case of remote access on a portable device 302, and also, for the portable device 302, based on the identity of the device itself. Additionally, based on the fact that personal user authentication is used, different access rights can be provided to different users. For example, users may be allowed, based on differing roles within the overall system, to view and/or edit files, access specific collateral or engineering files, or other types of restrictions. In some cases, users may be allowed to access product data based on only user of the portable device 302 for remote access, rather than via the web server 314 for administrative use.

Referring to FIG. 6, a system 400 is shown illustrating schematic access to data within the computing arrangement 300 of FIG. 5. In this embodiment, as shown, an API layer 402 is disposed between the web server 314 and web server 306, and the database layer (e.g., database server 310), portable devices 302, and cloud services storage 320. The API layer 402 can include read and write interfaces 404, 406, respectively, allowing for individual read or write access to data, based on such permissions as discussed above.

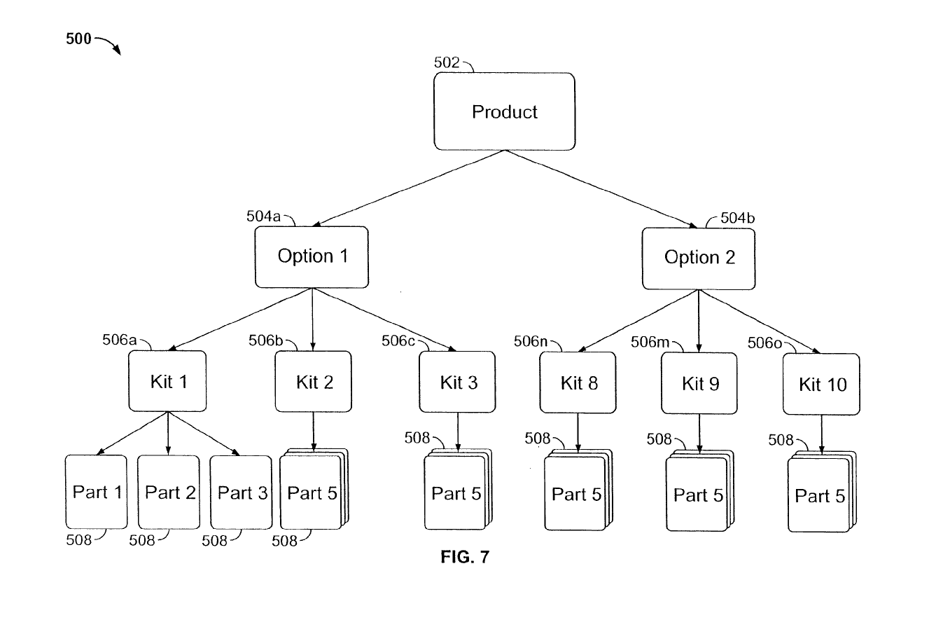

Referring now to FIG. 7, an example of a hierarchical arrangement 500 of part drawings within the systems discussed herein is provided. In the hierarchical arrangement 500, a product 502 can include one or more options 504 (shown as options 504a-b), such as different selectable configurations for the product. Each option can be associated with one or more kits 506 (shown as kits 506a-o), which may include, for example, separate collections of associated parts 508 that are used with each selected product option. Accordingly, a user of the system can select a product to view that product as well as underlying options, kits, and parts, or could also select parts to view.

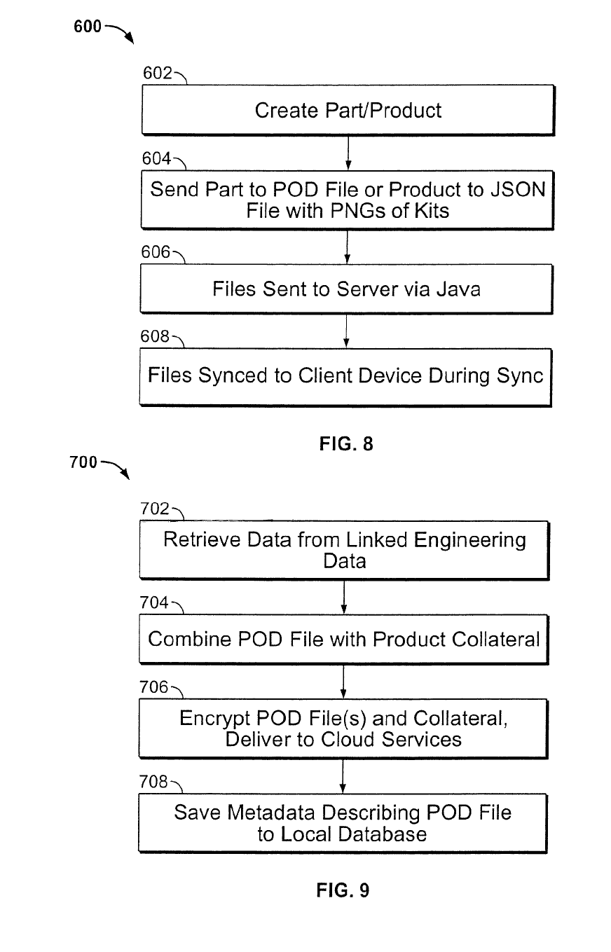

Referring to FIGS. 8-11, methods of loading, synchronizing, and accessing/viewing part and product data are illustrated, useable both in association with a web interface for administrative access (e.g., adding or editing part and product data), and a portable tool interface accessible by a portable device (e.g., portable device 302).

FIG. 8 illustrates a method of adding or editing part and/or product data into the systems discussed herein, for example using the computing arrangement 300 of FIG. 5, above. The method 600 includes creating a part or product (step 602), and sending that part or product to be converted for use in the system (step 604). This conversion can include, for example, converting a part file to a POD file, or packaging a product in the form of a JSON file that includes PNG illustrates of kits.

The method 600 includes transmitting the converted files to a server (e.g., database server 310) (step 606), which allows those files to be synchronized to a remote device (e.g., client system 120, or portable device 302) during a subsequent synchronization of part data with the device, when the device attempts access to the database server 310, for example as illustrated in FIG. 11.

FIG. 9 illustrates a method 700 of adding new part data to the database server 310 of FIG. 5. The method 700 can be performed, for example, to incorporate data from an engineering server 316 into database server 310 for access by remote users of portable devices 302.

In the embodiment shown, data is retrieved, for example by a web server 314 from the engineering server 316 (step 702). The method further includes combining a POD file, for example as created during a creation of the part associated with the imported data, with product collateral (step 704). The method 700 further includes encrypting the POD file and collateral files, and uploading those files to a cloud services storage 320 (step 706). Metadata associated with the POD file is then stored to the internal database, for example at database server 310 (step 708).

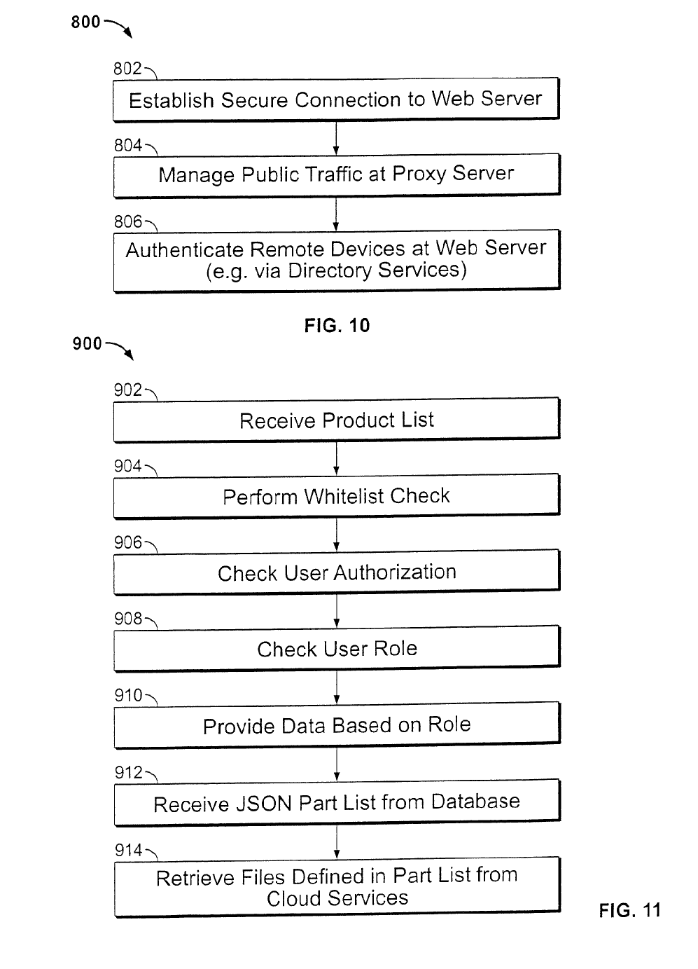

Following methods 600, 700, part data stored in an engineering server 316 can be incorporated into an accessible database for access by an authorized user of a portable device 302. As illustrated in FIGS. 10-11, connection by a portable device 302 is managed by interaction of the portable device and proxy server 304.

In FIG. 10, a device transmits a request for connection from the portable device 302, and establishes a secure connection between the portable device and a web server, such as web server 306 (step 802). Public internet traffic, and accordingly blocks unauthorized access attempts by devices not allowed to connect to the web server 306 (e.g., by maintaining a device whitelist). The device transmits authorization information to a directory services server 308 for user authentication, via proxy server 304. This ensures that unauthorized users cannot access part or product data using an authorized portable device (step 806).

FIG. 11 illustrates a method 900 performed following connection of the portable device 302 to the web server 306, and following user authentication via the directory services server 308. In FIG. 11, a portable device 302 receives a list of products, for example in a JSON file (step 902). The JSON file includes metadata defining one or more product assemblies, as well as defining a hierarchy of options and parts associated with each product. The proxy server 304 performs a whitelist check of the portable device 302, to determine if it is authorized to receive product data (step 904), and also checks the user authorization provided by the user of the portable device (step 906). Next, a user's role is checked, to determine whether the user has sufficient access rights to receive data, edit data, or otherwise access specific data (step 908). Based on the role determined by the directory services server 308, the user is provided requested data (step 910).

The portable device 302 retrieves an updated JSON-based parts list (step 912), allowing the user to access parts based on the updated parts information in the received JSON file. Based on the fact that the file was received in response to authorization, the portable device 302 can subsequently retrieve source files, including collateral or engineering files, from a cloud services storage 320 (step 914).

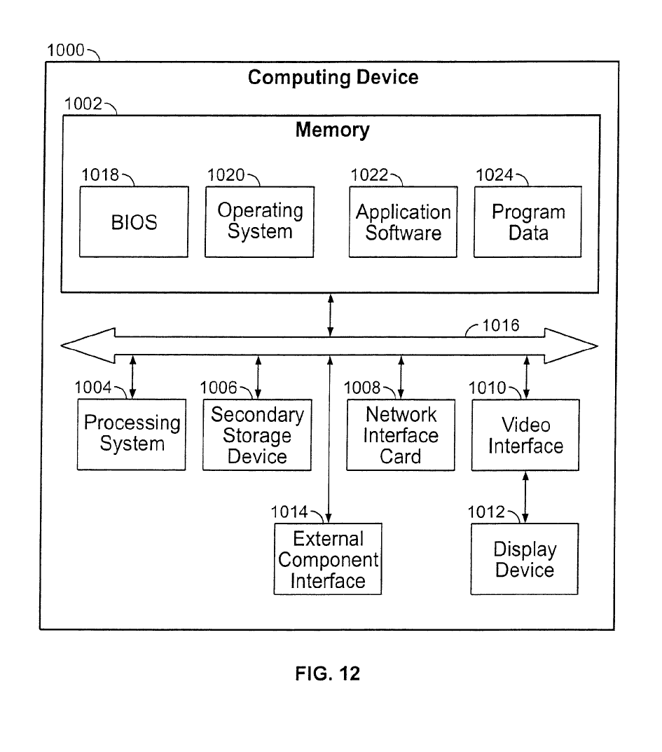

Referring now to FIG. 12, a block diagram illustrating an example computing device 1000 is shown, which can be used to implement aspects of the present disclosure. In particular, the computing device 1000 can represent a server, such as the product data server 102 of FIGS. 1-6, or any of the computing systems used by users within any of the communities of interest, as illustrated in FIGS. 1-6, and can be used to execute any of the methods or implement any of the systems discussed herein.

In the example of FIG. 12, the computing device 1000 includes a memory 1002, a processing system 1004, a secondary storage device 1006, a network interface card 1008, a video interface 1010, a display unit 1012, an external component interface 1014, and a communication medium 1016. The memory 1002 includes one or more computer storage media capable of storing data and/or instructions. In different embodiments, the memory 1002 is implemented in different ways. For example, the memory 1002 can be implemented using various types of computer storage media.

The processing system 1004 includes one or more processing units. A processing unit is a physical device or article of manufacture comprising one or more integrated circuits that selectively execute software instructions. In various embodiments, the processing system 1004 is implemented in various ways. For example, the processing system 1004 can be implemented as one or more processing cores. In another example, the processing system 1004 can include one or more separate microprocessors. In yet another example embodiment, the processing system 1004 can include an application-specific integrated circuit (ASIC) that provides specific functionality. In yet another example, the processing system 1004 provides specific functionality by using an ASIC and by executing computer-executable instructions.

The secondary storage device 1006 includes one or more computer storage media. The secondary storage device 1006 stores data and software instructions not directly accessible by the processing system 1004. In other words, the processing system 1004 performs an I/O operation to retrieve data and/or software instructions from the secondary storage device 1006. In various embodiments, the secondary storage device 1006 includes various types of computer storage media. For example, the secondary storage device 1006 can include one or more magnetic disks, magnetic tape drives, optical discs, solid state memory devices, and/or other types of computer storage media.

The network interface card 1008 enables the computing device 1000 to send data to and receive data from a communication network. In different embodiments, the network interface card 1008 is implemented in different ways. For example, the network interface card 1008 can be implemented as an Ethernet interface, a token-ring network interface, a fiber optic network interface, a wireless network interface (e.g., Wi-Fi, WiMax, etc.), or another type of network interface.

The video interface 1010 enables the computing device 1000 to output video information to the display unit 1012. The display unit 1012 can be various types of devices for displaying video information, such as a cathode-ray tube display, an LCD display panel, a plasma screen display panel, a touch-sensitive display panel, an LED screen, or a projector. The video interface 1010 can communicate with the display unit 1012 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 1014 enables the computing device 1000 to communicate with external devices. For example, the external component interface 1014 can be a USB interface, a FireWire interface, a serial port interface, a parallel port interface, a PS/2 interface, and/or another type of interface that enables the computing device 1000 to communicate with external devices. In various embodiments, the external component interface 1014 enables the computing device 1000 to communicate with various external components, such as external storage devices, input devices, speakers, modems, media player docks, other computing devices, scanners, digital cameras, and fingerprint readers.

The communication medium 1016 facilitates communication among the hardware components of the computing device 1000. In the example of FIG. 12, the communication medium 1016 facilitates communication among the memory 1002, the processing system 1004, the secondary storage device 1006, the network interface card 1008, the video interface 1010, and the external component interface 1014. The communication medium 1016 can be implemented in various ways. For example, the communication medium 1016 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 1002 stores various types of data and/or software instructions. For instance, in the example of FIG. 12, the memory 1002 stores a Basic Input/Output System (BIOS) 1018 and an operating system 1020. The BIOS 1018 includes a set of computer-executable instructions that, when executed by the processing system 1004, cause the computing device 1000 to boot up. The operating system 1020 includes a set of computer-executable instructions that, when executed by the processing system 1004, cause the computing device 1000 to provide an operating system that coordinates the activities and sharing of resources of the computing device 1000. Furthermore, the memory 1002 stores application software 1022. The application software 1022 includes computer-executable instructions, that when executed by the processing system 1004, cause the computing device 1000 to provide one or more applications. The memory 1002 also stores program data 1024. The program data 1024 is data used by programs that execute on the computing device 1000.

Although particular features are discussed herein as included within an electronic computing device 1000, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, DDR4 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Computer storage media generally excludes transitory wired or wireless signals. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

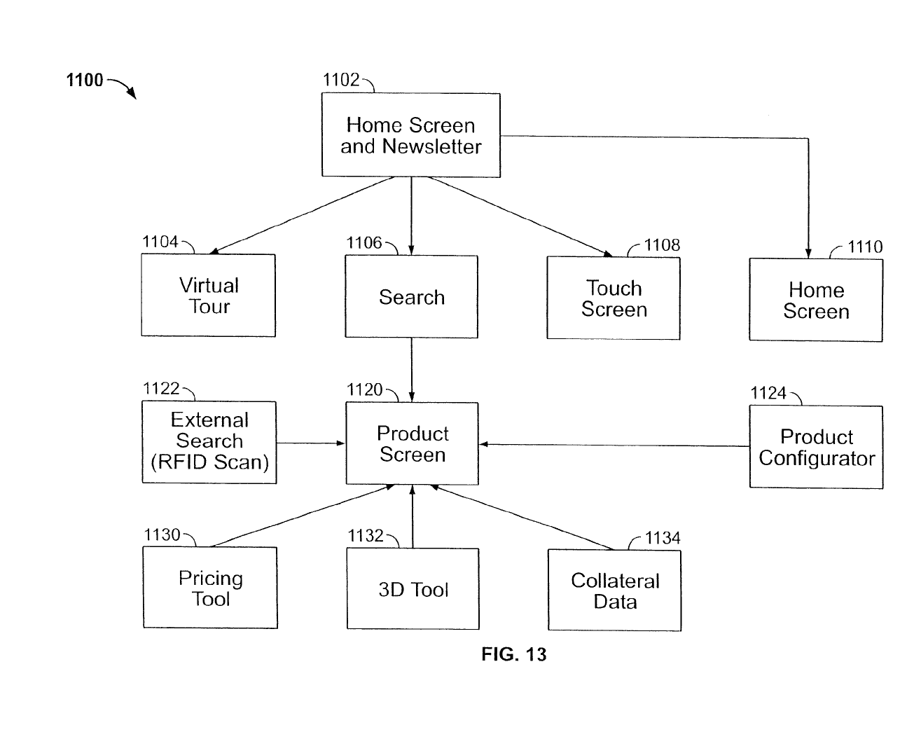

Referring now to FIG. 13, an example block diagram 1100 illustrating user interface functionality is illustrated which are useable in the integrated three dimensional product access and display systems described herein. In the embodiment shown, a home screen 1102 can lead to any of a plurality of search options, including a virtual tour 1104, a search screen 1106, a touch screen 1108, or a home screen 1110. The virtual tour 1104 allows a user to view a virtual version of a facility at which products are to be installed or at which they are installed, while the search, touch, and home screens 1106-1110 allow a user to select products for display and review.

From the search screen 1106 or touch screen 1108 to select a product, a product screen 1120 is reached. The product screen 1120 can also be reached by way of an external scan of a product (e.g., via RFID or bar code) or by use of a product configurator selection process screen 1124. From the product screen, various output data can be reached, including pricing information in a pricing tool 1130, a depiction of the product in a 3D tool 1132, and other collateral data in a collateral data tool 1134. Examples of such screens, or configuration of data to be included in such screens, are depicted in FIGS. 14-37, discussed below.

Referring now to FIGS. 14-32, various depictions of a graphical user interface 1200 are provided, illustrating an example arrangement of display components capable of being generated by client system 120, such as portable device 302. Although in the embodiment shown, the client system 120 is shown as a tablet-style mobile computing system, it is noted that a variety of other types of client systems could be used as well, such as a smartphone, computing system or a desktop system.

In FIG. 14, the user interface 1200 is presented such that a three-dimensional representation of a currently-selected product 1202 is displayed. Additional navigation features, including a search drop-down button 1206, can be provided as well. Generally, the three-dimensional representation of the currently-selected product 1202 is manipulable, such that various views of the product are possible.

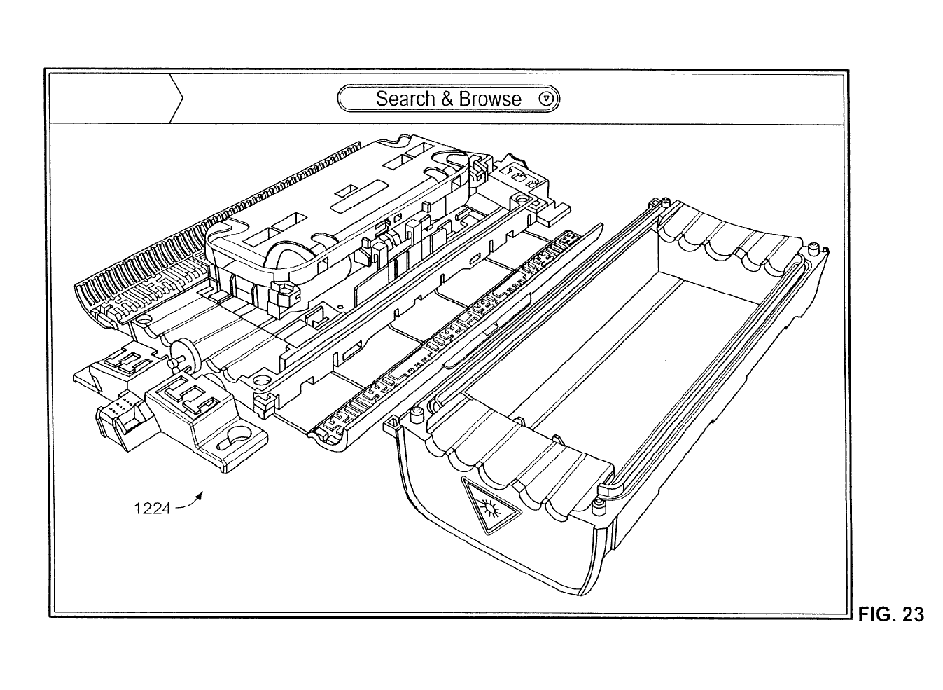

FIG. 15 illustrates the user interface 1200 with a menu button 1204 included, and upon selection of the “browse” option on the search drop-down button 1206. In this view, the menu button 1204 generally allows a user to access and view accompanying documentation associated with the product 1202, while the search drop-down button 1206 allows users to search for documentation associated with a particular product, or for a different product altogether (e.g., as illustrated in FIGS. 23-25). Additional details regarding the menu button 1204 are provided below. In general, the currently-selected product 1202 can be selected, for example using a mouse or gesture motions, to rotate and zoom in on the product, such that a user can view details of the three-dimensional representation.

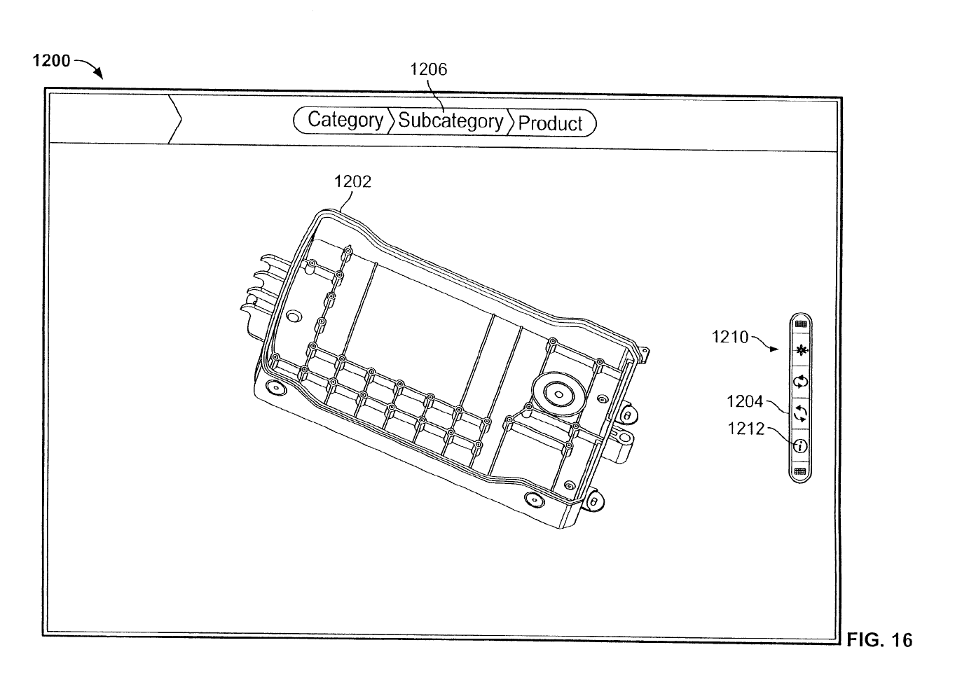

FIG. 16 shows the user interface 1200 upon selection of the menu button 1204. A plurality of additional buttons appear upon selection of the menu button 1204, including various buttons 1210 for rotating the three-dimensional product, as well as an information button 1212 through which product information can be accessed. Details regarding available product information available via the information button 1212 are provided below.

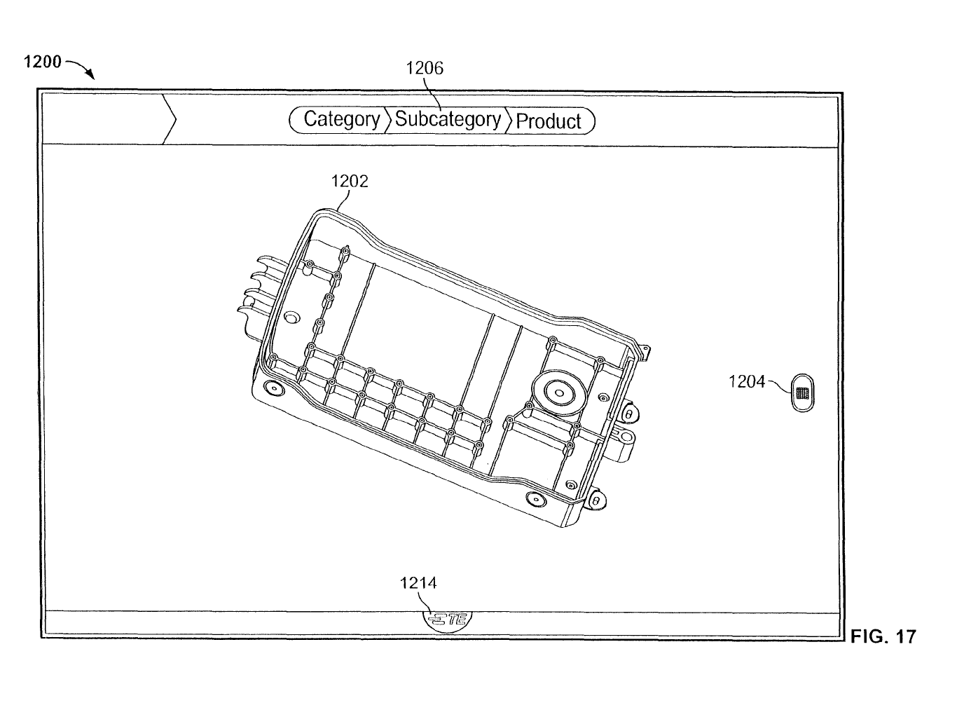

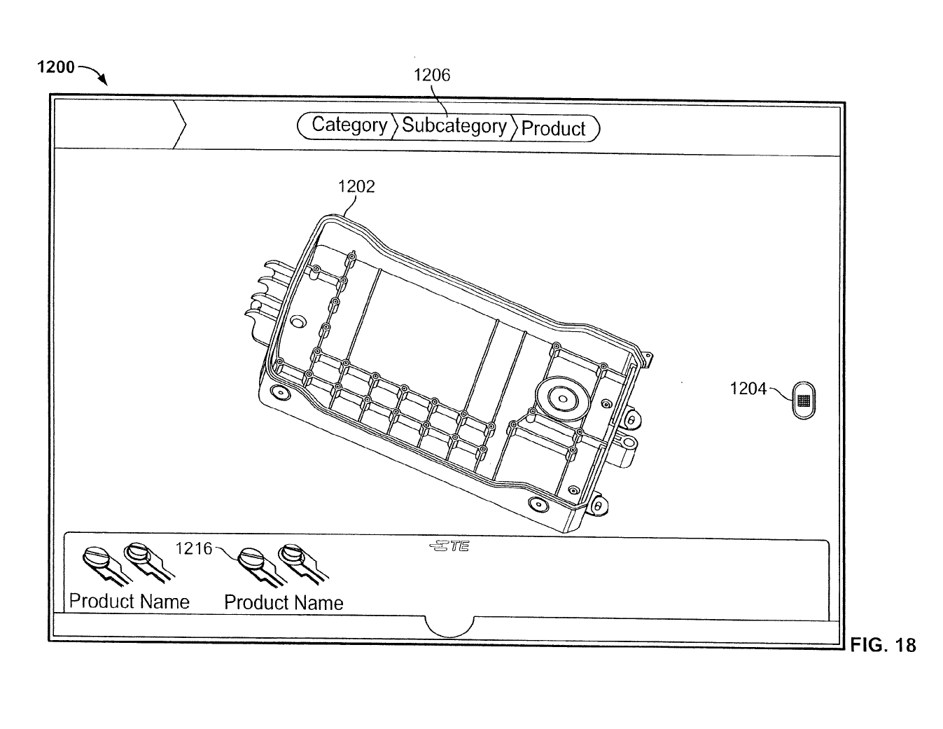

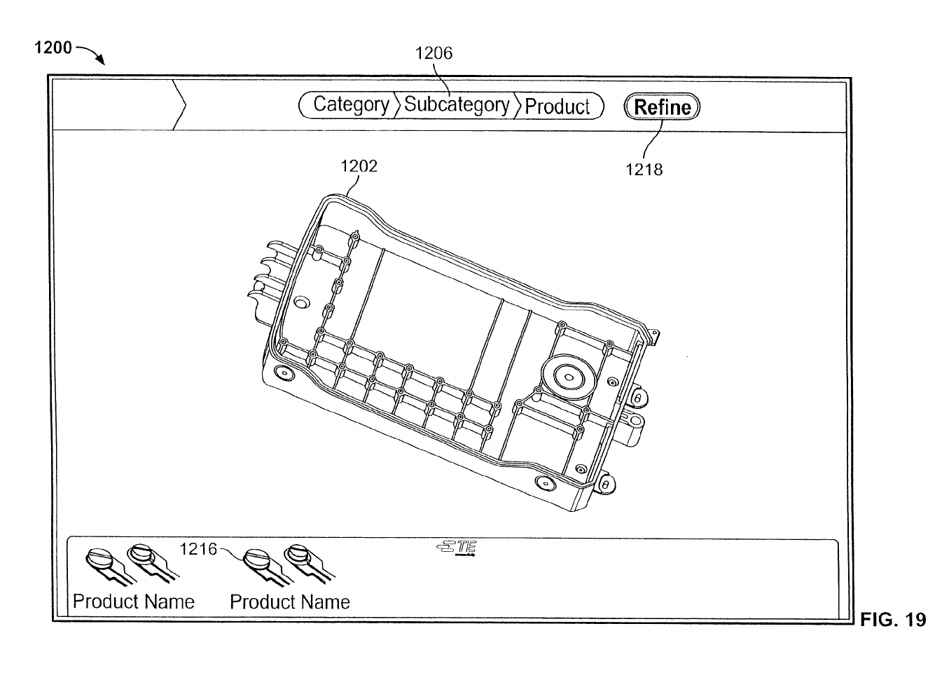

Now referring to FIGS. 17-19, selection of accessories that could accompany the currently-selected product 1202 is shown, using the user interface 1200. As seen in FIG. 17, an accessories bar 1214 along a bottom of the screen can be selected and expanded (compare FIGS. 17-18), thereby causing an accessories menu 1216 to be displayed, as seen in FIGS. 18-19. In the accessories menu 1216, each of the accessories associated with the currently-selected product can be displayed for selection and viewing. Furthermore, as illustrated in FIG. 19, a refine option 1218 allows a user to sub-select from among available accessory products, for example to allow the user to determine a correct accessory or type of accessories for display in the accessories menu 1216.

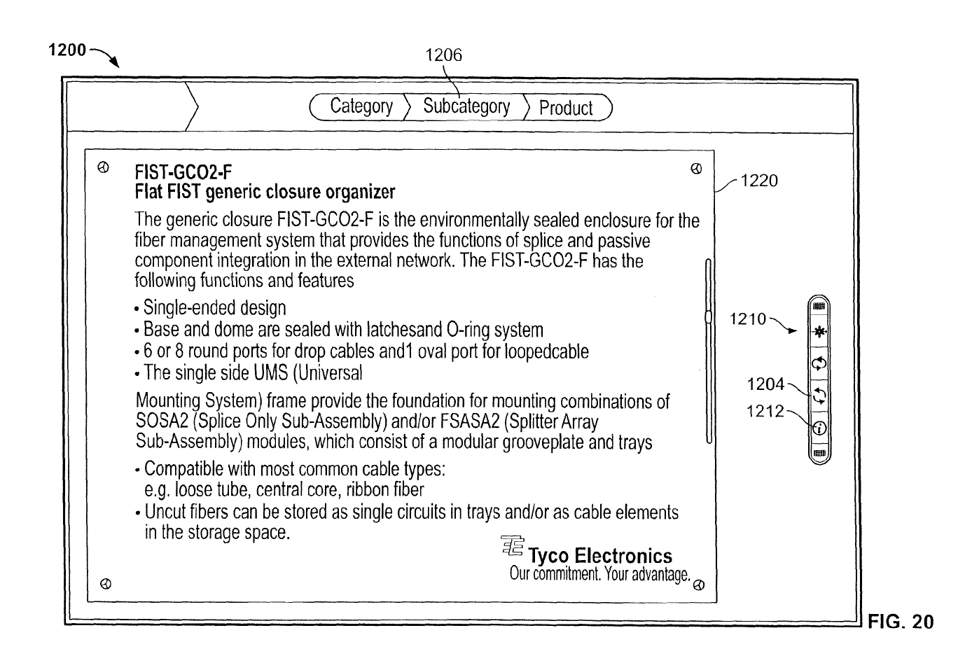

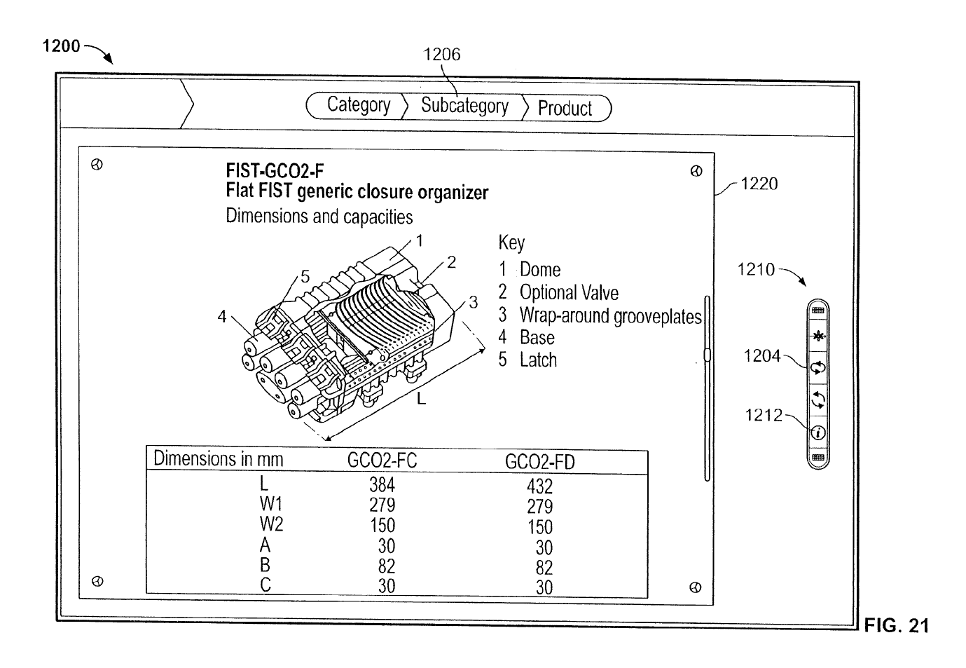

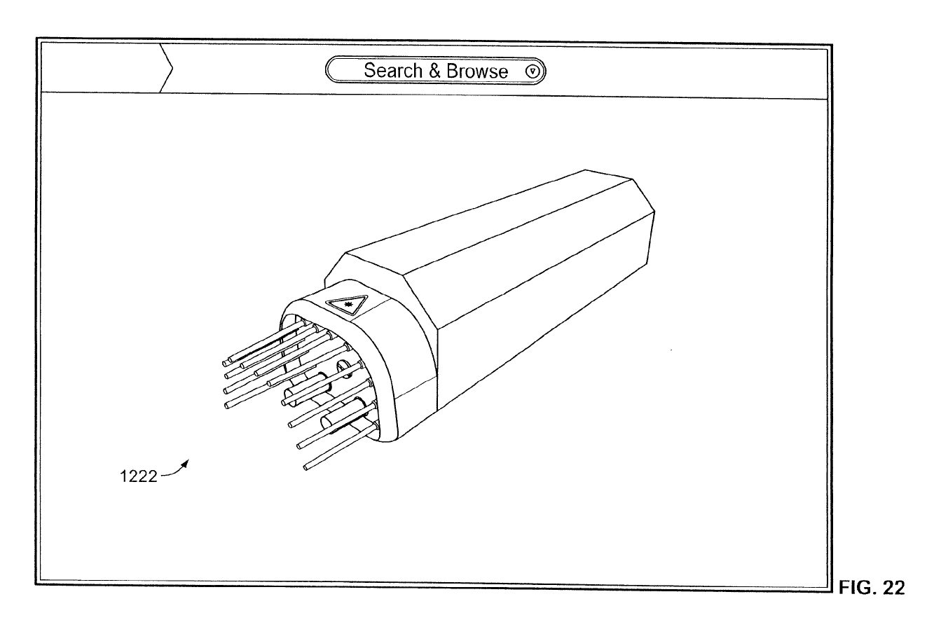

FIGS. 20-21 illustrates an information screen 1220 within the user interface 1200 that is displayed upon selection of the information button 1212. As illustrated, the information screen 1220 displays textual information about the currently selected product 1202, and optionally can also display other available information, such as engineering or dimensional drawingsln addition, FIGS. 22-23 illustrates related products screens 1222, 1224 which display associated products that are typically used in assemblies in conjunction with the currently selected product 1202. Using the related products screen 1222, 1224, a user can select and view those related products (including in context with the currently selected product, as in screen 1224), as well as data sheets, ordering information, etc. as discussed above, and can also elect to view three-dimensional images of the currently selected product and one or more related products, such as in an assembly of those products. Other views, and manipulations of one or more products, are possible as well.

As illustrated in FIGS. 14-23, the views of a particular product can be, in some embodiments, presented over cross-hatched background, highlighting the three-dimensional view of the product. Other variations of background colors and themes, such as using a background that fades from light to dark, or other appearance, are possible as well.

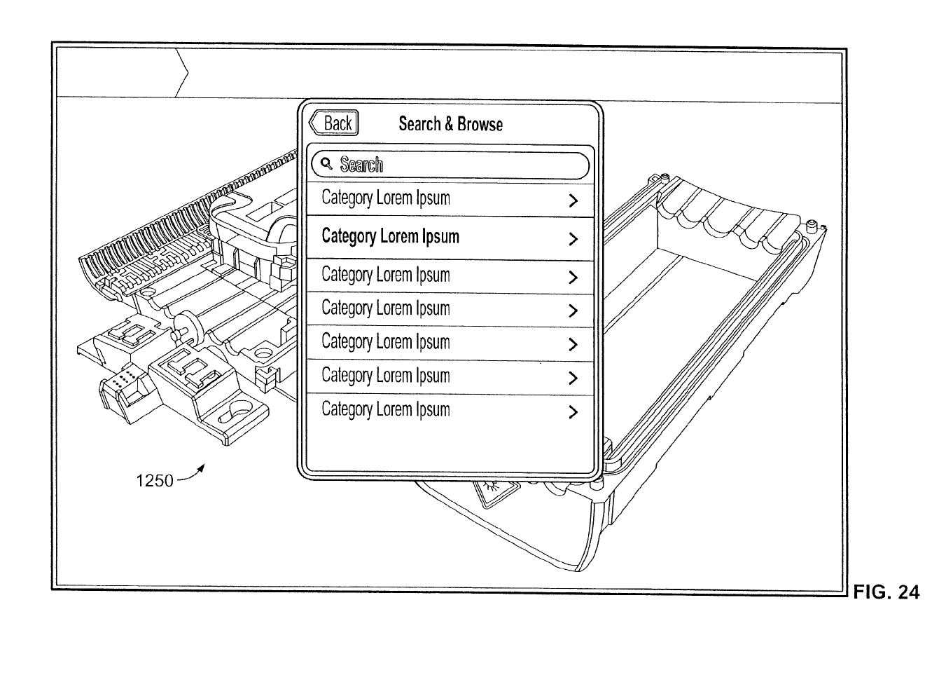

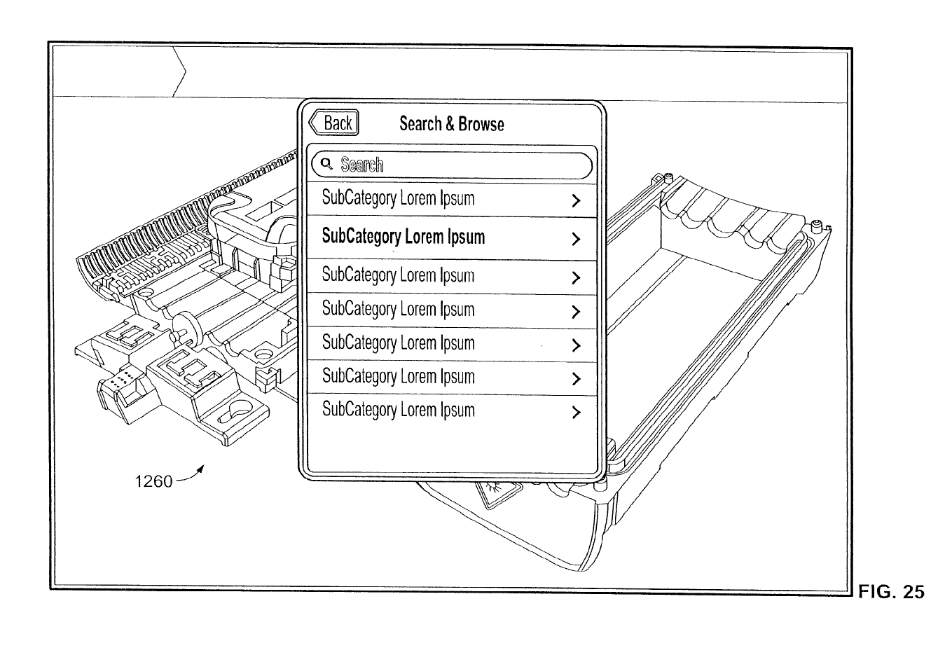

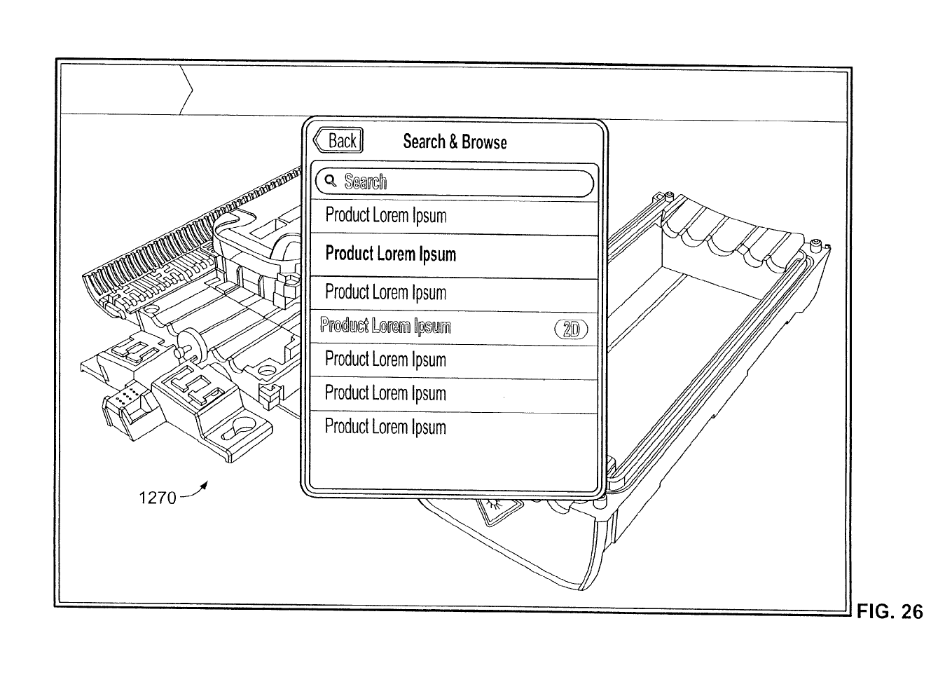

FIGS. 24-26 illustrate product search and navigation screens useable in connection with the user interface 1200 and associated screens of FIGS. 13-22 to select a particular product. FIG. 24 illustrates a search screen 1250 for searching for a product or categories of products, as well as browsing categories of products. Similarly, FIG. 25 illustrates a search screen 1260 for searching for a product or product subcategory, as well as for browsing of subcategories. In some embodiments, the search screen 1260 is reached upon selection of a particular category in the search screen 1250, or selection of the “subcategory” designation on the search drop-down button 1206. Additionally, FIG. 26 illustrates a product search screen 1270 for searching for or browsing products, and can be reached via the subcategory search screen 1260 or via the search drop-down button 1206. Other product selection features or search functionalities could be included in the user interface 1200 or other associated screens as well.

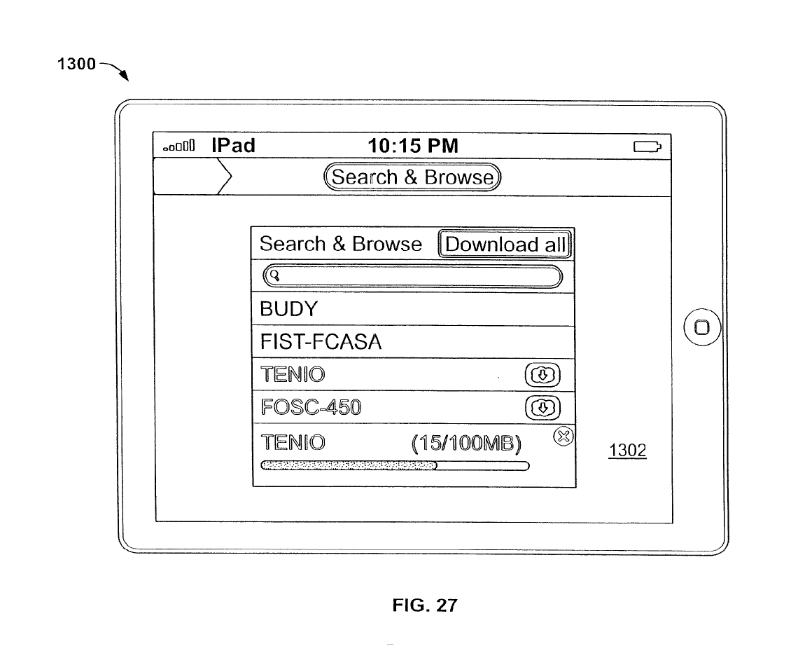

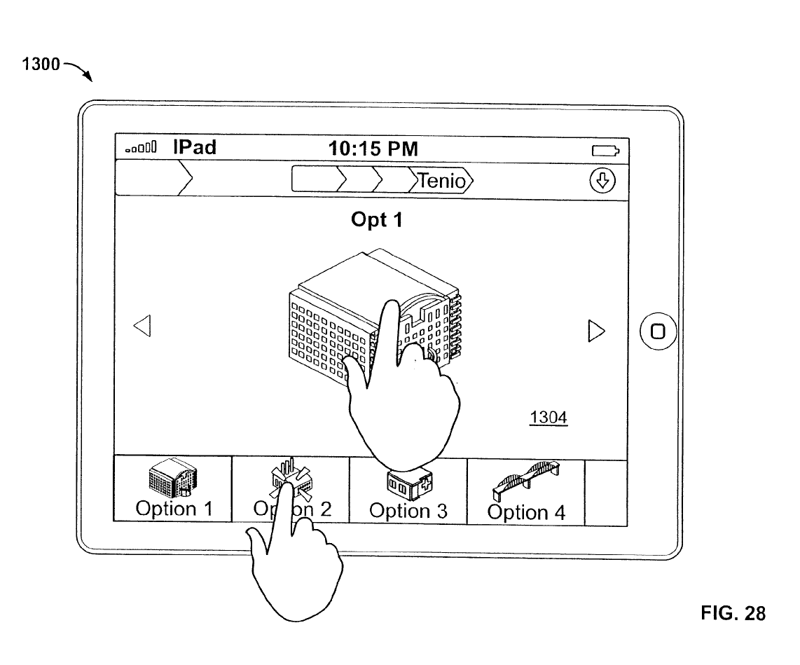

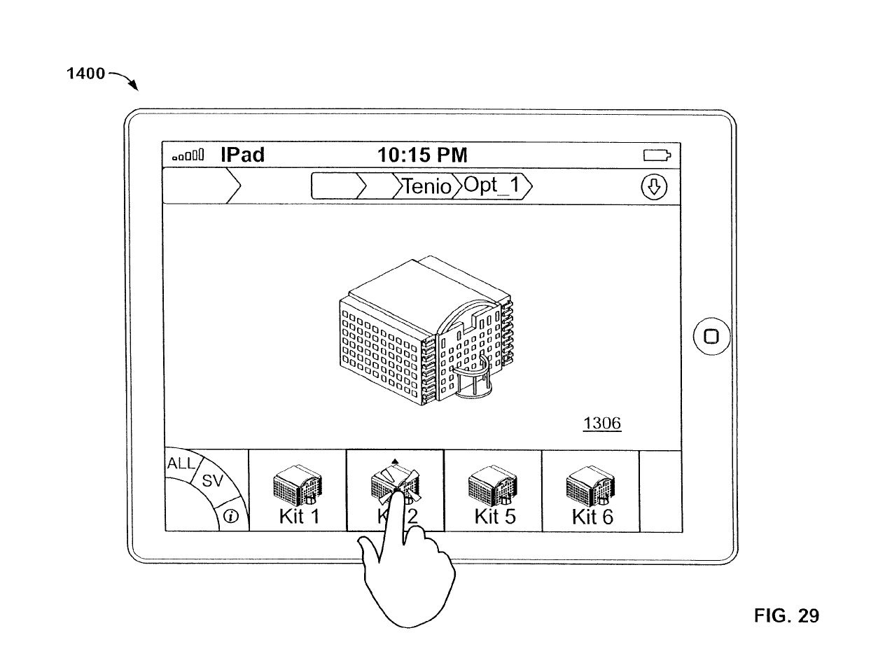

FIGS. 27-31 illustrate further examples of user interface screens, in particular for a user interface 1300, useable on a client system 120, such as portable device 302, for accessing and viewing product or part data. FIG. 27 illustrates user interface 1300 depicting an example search and browse screen 1302, which allows a user to view various products and product assemblies, or to perform a keyword search of available products/parts. FIG. 28 illustrates user interface 1300 depicting an example option screen 1304, in which a user can select from among a plurality of options, once a particular product has been selected (e.g., using search and browse screen 1302). As seen in FIG. 29, a user interface 1300 shows selection of one or more kits in a kit selection screen 1306. The kits can be, for example, based on the selected option of FIG. 28.

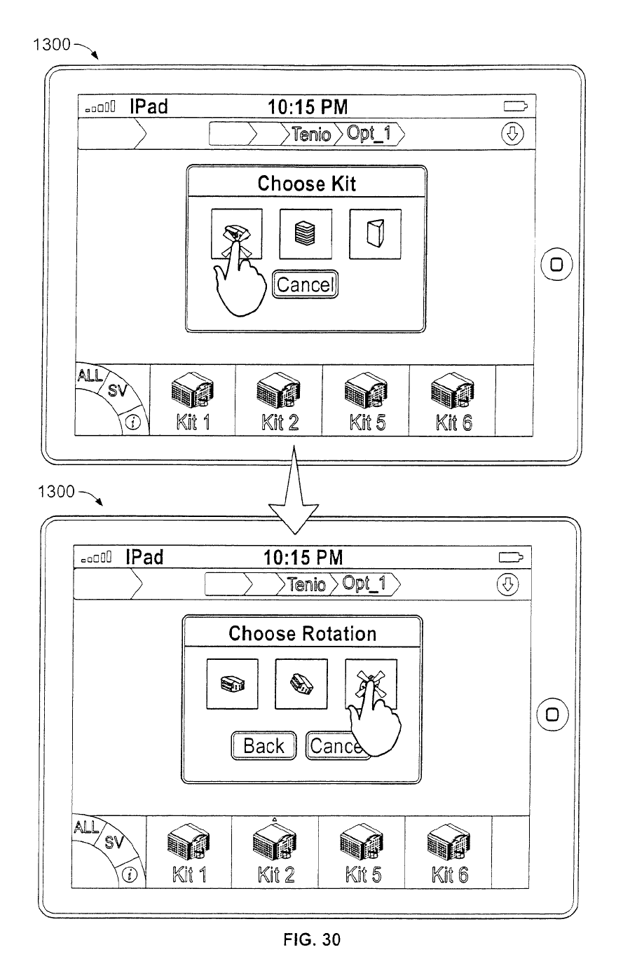

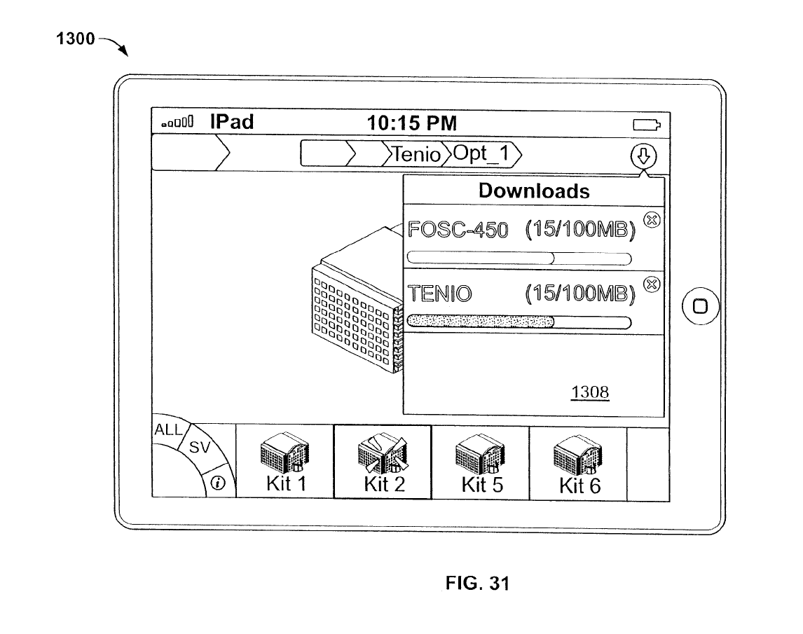

FIG. 30 illustrates the user interface 1300, in which a sequence is illustrated for selection of both a kit and associated rotation. Finally, FIG. 31 illustrates user interface 1300 including a download status region 1308, showing a status of downloading part files associated with the particular product, option, and kit.

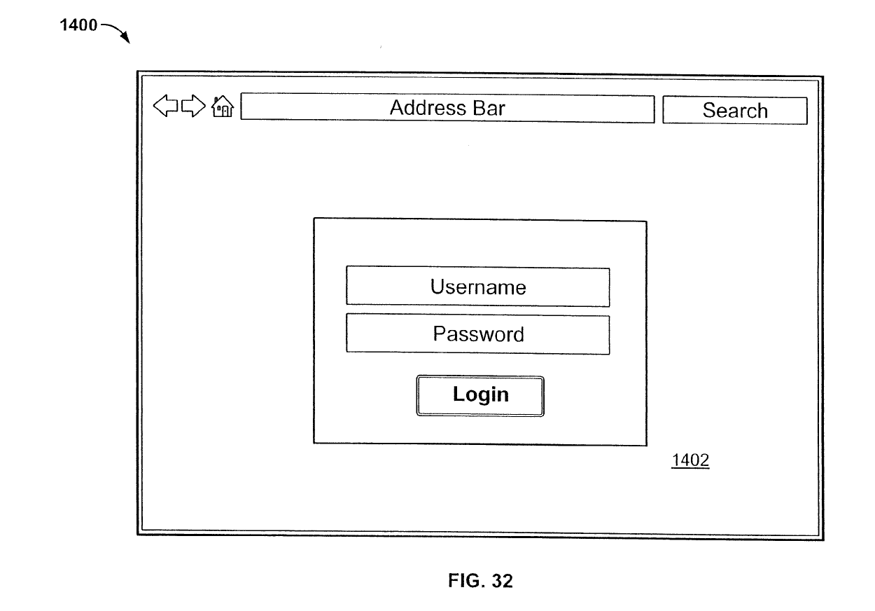

Referring now to FIGS. 32-37, various depictions of a graphical user interface xxx are provided, illustrating an example arrangement of display components capable of being generated by client system 120, such as general purpose computing system used for administrative access within the systems discussed herein. It is noted that a variety of types of client systems could be used, such as a smartphone, computing system or a desktop system, examples of which are discussed above in connection with FIG. 12.

As illustrated in FIG. 32, a user interface 1400 is depicted for a web-based administrative tool useable by authorized users to access and edit parts information made accessible using the methods and systems described herein. The user interface 1400 in FIG. 32 presents a login screen 1402 for providing user authentication information, which will be relayed to a directory services server 308 to authenticate a user prior to allowing that user to access/edit the database.

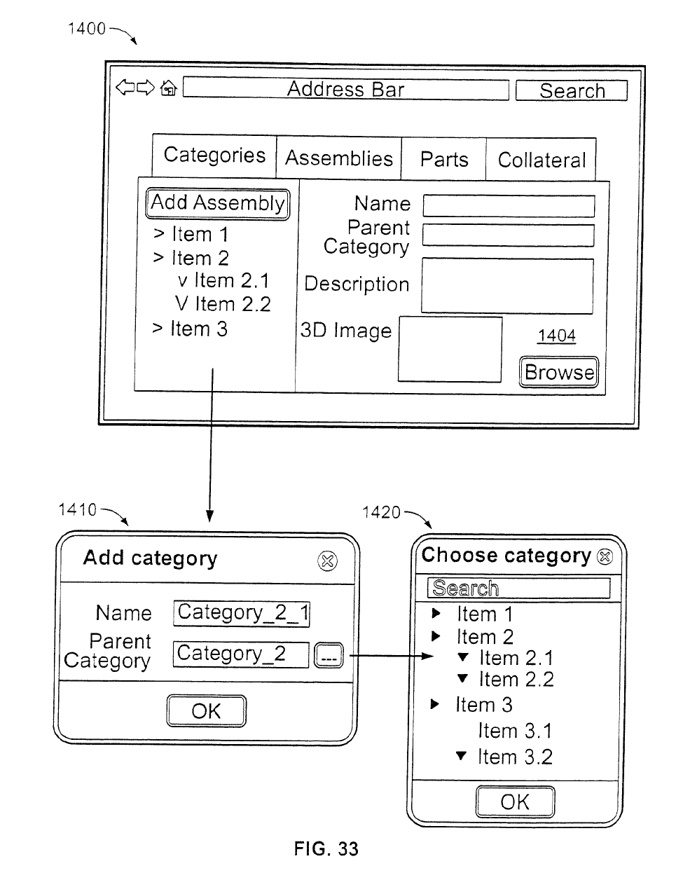

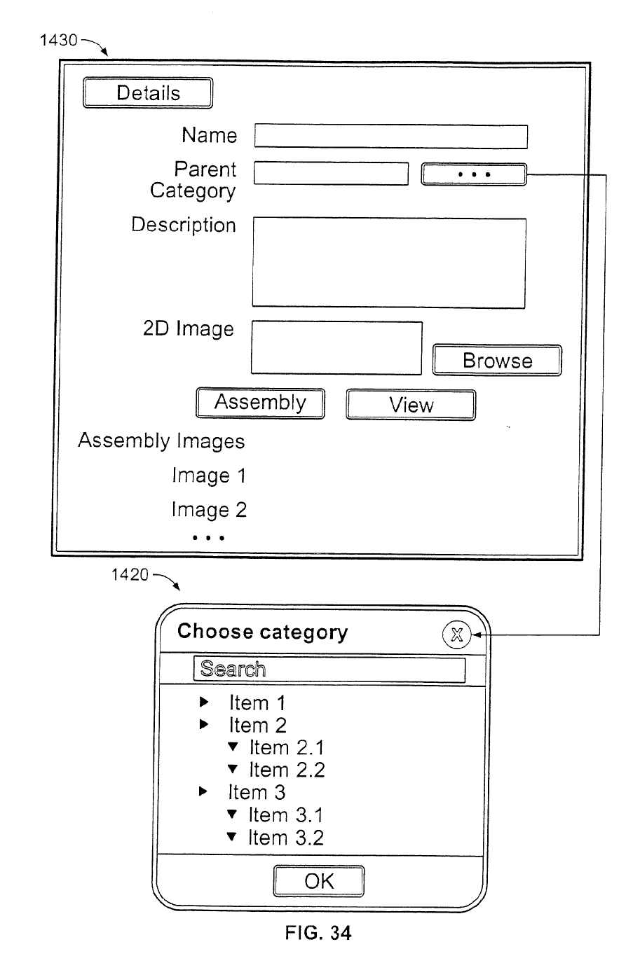

FIG. 33 illustrates the user interface 1400 following authentication, and shows an arrangement including categories, assemblies, parts, and collateral tabs. In the example shown, the categories tab is illustrated as active, thereby allowing a user to view the categories region 1404 which includes a category list and associated editing functionality allowing a user to associate name, category, description, and image information with a particular assembly. By selecting an add assembly option in the categories region, an add category screen 1410 can be generated, allowing a user to further define additional items to be included in the category list, which is depicted in category screen 1420. As seen in FIG. 34, an assembly definition screen 1430 can be used to define name, category, description, and image information with a particular assembly; a button can be included in the assembly definition screen 1430 to generate the category screen 1420 as well.

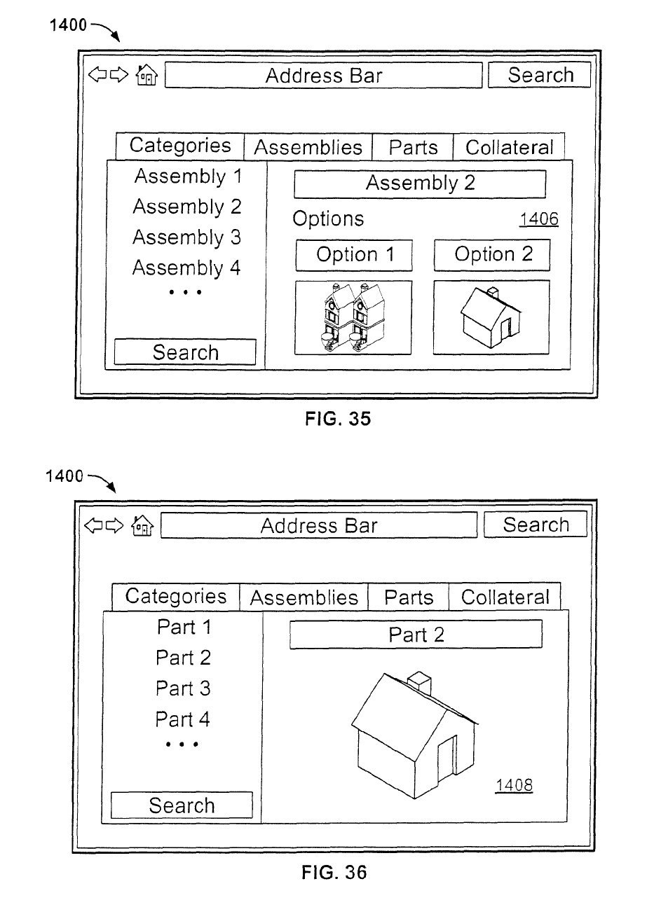

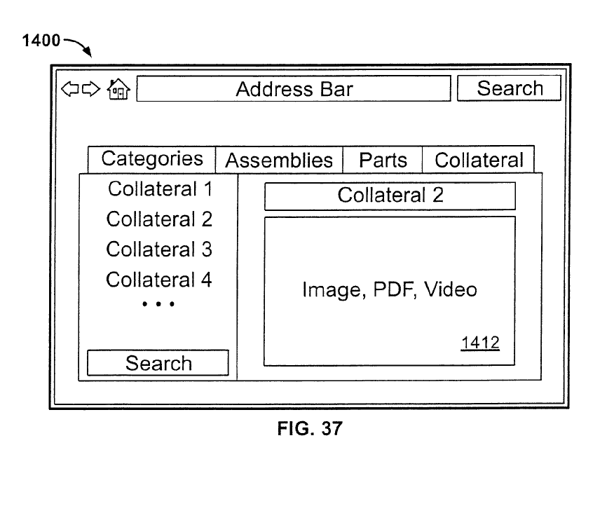

FIG. 35 illustrates the user interface 1400 in which the assemblies tab is active, and which depicts an assemblies region 1406 that allows a user to select a particular assembly and any associated options. FIG. 36 depicts the user interface 1400 in which the parts tab is active, and which depicts a parts region 1408 that allows the user to select from among the parts that are associated with an assembly and option, for viewing and/or editing. FIG. 37 depicts the user interface 1400 in which the collateral tab is active, and which depicts a collateral region 1412 that allows users to view, access, and upload collateral data associated with a particular category, assembly, or part. That collateral can be, for example, a document, image, or video associated with the part or product.

Referring now to FIGS. 1-37 generally, it is recognized that the integrated three-dimensional product access and display systems described herein has a number of advantages over prior art systems. For example, by integrating engineering and sales information, up-to-date functional specification of each part can be reliably provided across an organization and to that organization's customers. Furthermore, linked product information simplifies the process of accessing different types of information for users within the organization as well, particularly new employees who may not be familiar with an organization's product offerings and may therefore not be aware of particular parts or products that are available, or the appearance of such products. In particular, it is recognized that the integrated three-dimensional product access and display system 100 of the present disclosure allows a user, such as any of users 120a-e, to access data including three-dimensional product data on a mobile device, thereby allowing that user to visualize a particular product or part. Furthermore, use of a simplified, graphical ordering guide and product selector allows for ease of accessing information as well, despite the possibility of disparate file types, disparate naming conventions, or other communication issues. Such access of information is also managed based on user roles and multiple authentication processes, thereby ensuring that correct users have access to correct data, and have associated access rights. Other advantages exist as well.

The above specification, examples and data provide a complete description of the manufacture and use of the composition of the invention. Since many embodiments of the invention can be made without departing from the spirit and scope of the invention, the invention resides in the claims hereinafter appended.

### PARTS LIST

100 display system
102 product data server
104 product database
106 design specification
108 design drawings
109 product assembly numbers
110 ordering numbers
112 item numbers
116 three-dimensional views
118 dimensional thumbnail views
120 client system
120a engineering personnel
120b product management
120c operations personnel
120d sales personnel
120e customer
122 communications network
140 operational software
141 security module
142 database management system
144 linking software
146 web server interface
148 product selector component
150 materials
152 ordering guide
154 pricing information
156 up-to-date installation instructions
180 client interface software
182 user interface module
184 search module
186 three-dimensional rendering module
188 ordering module
190 enterprise resource planning server
192 database
200 process flow
202 design phase
204 product management phase
206 communications phase
208 operations phase
300 computing arrangement
302 portable device
304 proxy server
306 web server
308 directory services server
310 database server
310 product data server
312 file server
314 web server
316 engineering server
320 cloud services storage
400 system
402 api layer
404 interfaces
406 interfaces
500 hierarchical arrangement
502 product
504 options
506 kits
508 parts
1000 computing device
1000 electronic computing device
1002 memory
1004 processing system
1006 secondary storage device
1008 network interface card
1010 video interface
1012 display unit
1014 external component interface
1016 communication medium
1018 bios
1020 operating system
1022 application software
1024 program data
1100 block diagram
1102 home screen
1104 virtual tour
1106 home screens
1106 search screen
1108 touch screen
1110 home screen
1120 product screen
1124 product configurator selection process screen
1130 pricing tool
1132 tool
1134 collateral data tool
1200 user interface
1202 currently selected product
1204 menu button
1206 search drop-down button
1210 button
1212 information button
1214 accessories bar
1216 accessories menu
1218 refine option
1220 information screen
1222 related products screen
1224 related products screen
1250 search screen
1260 subcategory search screen
1270 product search screen
1300 user interface
1302 browse screen
1304 option screen
1306 kit selection screen
1308 download status region
1400 user interface
1402 login screen
1404 categories region
1406 assemblies region
1408 parts region
1410 category screen
1412 collateral region
1420 category screen
1430 assembly definition screen

1. A system for accessing product data, the system comprising:
a product data server hosting a database, the database including:
a first product document describing a product, the first product document generated by a first user within a first community of interest and having a first document format and identified using a first data identifier having a first data identifier format;
a second product document describing the product and having a second document format different from the first document format, the second product document generated by a second user within a second community of interest different from the first community of interest and including dimensional data associated with at least a part of the product, the second product document identified using a second data identifier different from the first data identifier;
a product linker component operating on the product data server and configured to associate the first product document and the second product document with the product; and
a renderer component configured to generate one or more graphical images in response to a request from a client system, the one or more graphical images generated based at least in part on the dimensional data in the second product document on or after a time at which the request is received.

2. The system of claim 1, wherein the one or more graphical images comprise three-dimensional graphical images.

3. The system of claim 1, wherein the first community of interest and the second community of interest are communities of interest associated with an organization, the communities of interest associated with an organization selected from a group consisting of:
engineering designers;
product management;
operations personnel;
sales personnel; and
customers.

4. The system of claim 1, wherein the first product document comprises product literature, and the second product document comprises an engineering drawing document.

5. The system of claim 1, wherein the first identifier comprises a product ordering number useable within an enterprise resource management system, and wherein the second identifier comprises a product drawing number assigned within computer-aided design software.

6. The system of claim 1, wherein the dimensional renderer component operates on the product data server.

7. The system of claim 1, wherein the dimensional renderer component operations on a client system remote from and communicatively connected to the product data server.

8. The system of claim 1, further comprising a plurality of computing systems communicatively connected to the product data server, each of the plurality of computing systems configured to generate a user interface with which a visual search of the database can be performed.

9. The system of claim 1, wherein the product data server further includes a product selector component configured to guide a user to an appropriate product in response to a search request.

10. The system of claim 1, wherein the product data server is configured to generate a plurality of integrated document reports, the integrated document reports including information from the first product document and the second product document and selected from a group of reports consisting of:
ordering guides;
order information;
marketing guides;
engineering drawings;
cost information;
product availability information;
installation instructions;
bills of materials; and
pricing reports.

11. The system of claim 1, wherein the product linker component associates a linking identifier with the first and second product document, thereby associating both the first and the second product document with the product.

12. The system of claim 1, wherein the product data server is configured to receive additional product information from a remote server.

13. The system of claim 11, wherein the remote server comprises an enterprise resource planning server, and wherein the additional product information includes price or ordering information.

14. The system of claim 1, wherein the product data server comprises a data server storing metadata of the product information, and a cloud services storage area configured to store source files associated with the metadata.

15. The system of claim 1, further comprising a proxy server controlling access to the product data server, the proxy server maintaining a device whitelist and routing user authentication information to a directory services server to authenticate a user and device attempting access to the product data server.

16. The system of claim 1, wherein the first community of interest and the second community of interest have different access rights to product data on the product data server.

17. The system of claim 1, wherein the product data server is accessible administrative web interface.

18. A method of accessing product data managed by a product data server, the method comprising:
generating a user interface displayable on a client computing system, the user interface providing a visual search interface useable to select one or more products by visual appearance, the visual appearance defined at least in part by a dimensional thumbnail image;
transmitting a selection of the dimensional thumbnail image to the product data server; and
in response, receiving a listing of one or more documents associated with the product represented by the dimensional thumbnail image and available for retrieval from the product data server, the documents generated by users in a plurality of different communities of interest and each having a different document format and identified by identifiers having different formats, the documents including a view of at least a portion of the product, computer-aided design drawings of the product, and ordering information associated with at least part of the product.

19. The method of claim 18, further comprising transmitting a request to the product data server for the view of the at least a portion of the product, and, in response, receiving the view on or after a time at which the request is received.

20. The method of claim 19, wherein the view is based on updated data provided to the product data server using an identifier unassociated with the product at the client computing system, and wherein a linker component at the product data server associates the view with the product.

21. The method of claim 18, wherein the view comprises a three-dimensional view of at least a portion of the product.

22. A computer-storage medium configured to store computer-executable instructions which, when executed, cause the computing system to execute a method for accessing product data managed by a product data server, the method comprising:
generating a user interface displayable on a client computing system, the user interface providing a visual search interface useable to select one or more products by visual appearance, the visual appearance defined at least in part by a dimensional thumbnail image;
transmitting a selection of the dimensional thumbnail image to the product data server; and
in response, receiving a listing of one or more documents associated with the product represented by the dimensional thumbnail image and available for retrieval from the product data server, the documents generated by users of a plurality of different communities of interest and each having a different document format and identified by identifiers having different formats, the documents including a three-dimensional view of at least a portion of the product, computer-aided design drawings of the product (108), and ordering information associated with at least part of the product.

23. A method of accessing product data, the method comprising:
receiving, at a proxy server, a request for access from a portable device;
receiving, at the proxy server, user credentials from a user of the portable device;
based on the identity of the portable device and the user credentials permitting access by the portable device to a web server;
generating a user interface providing a visual search interface useable to select a part and view documentation associated with one or more products, kits, or parts, the documentation including: a three dimensional view, a thumbnail, a design drawing, a product specification, product collateral, and pricing information;
wherein access rights to the documentation varies based on the user credentials of the user.

24. The method of claim 23, wherein the product collateral includes installation instructions and an ordering guide.

25. The method of claim 23, further comprising receiving a second request for access from a computing system associated with an administrative user, and, based on user credentials of the administrative user, delivering an administrative user interface from an administrative web server.

26. The method of claim 25, wherein the administrative web interface allows the administrative user to define products, product assemblies, and parts to be incorporated into a data server.

27. A system for accessing product data, the system comprising:
a product data server storing information describing a plurality of products, each product including one or more options, one or more kits associated with each option, and one or more parts including in each kit;
an administrative web server providing an administrative user interface allowing an administrative user to extract data from an engineering server for integration into the product data server;
a web server providing a user interface allowing users of portable devices to view documents associated with each product, the documents including documents identified by different naming conventions, including product assembly numbers, order numbers, item numbers, and release numbers, the user interface presenting a three-dimensional version of the product and the documents including one or more of installation instructions, an ordering guide, a bill of materials, pricing data, design specifications, and design drawings;
a proxy server configured to control access to the web server and data in the product data server based on identification of a client device and a user of the client device.

28. The system of claim 27, wherein the product data server stores metadata associated with each product, and wherein documents associated with the products are stored at a cloud storage services location.

29. The system of claim 28, wherein the web server provides a parts list to the portable device from which documents can be selected for retrieval from the cloud storage services location.

30. The system of claim 27, further comprising a directory server used to authenticate the users of portable devices and the administrative user.

31. The system of claim 27, further comprising an application programming interface controlling read and write access to product data in the database.
